(19) United States
(12) Patent Application Publication
(10) Pub. No.: US 2013/0091156 A1
(43) Pub. Date: Apr. 11, 2013

(54) TIME AND LOCATION DATA APPENDED TO CONTACT INFORMATION

(71) Applicants: Samuel B. Raiche, Long Lake, MN (US); Adam Jay Falkauff, Brooklyn, NY (US)

(72) Inventors: Samuel B. Raiche, Long Lake, MN (US); Adam Jay Falkauff, Brooklyn, NY (US)

(21) Appl. No.: 13/267,396

(22) Filed: Oct. 6, 2011

(51) Int. Cl. G06F 17/30

(52) U.S. Cl. 707/758; 707/E17.014; 707/E17.032

(57) ABSTRACT

On a handheld device, a user enters new contact information to create a new contact entry, and a time stamp and geographic location are automatically added to the new contact entry. Therefore, when the user later views that contact entry, the location and time when the user gathered that contact information is noted. This can assist the user in identifying the particular individual represented by the contact entry.

### BACKGROUND

Handheld computing devices are currently in wide use. Some common handheld computing devices include cellular telephones, smart phones, personal digital assistants (PDAs) and slate computers, to name a few. These types of handheld devices differ from other, larger computing devices (such as desktop computers, servers and laptop computers) in that they are normally held in the hand, while the other computing devices are normally used upon a work surface. As such, handheld devices can be easily transported by a user in nearly every environment, such as to work, to conventions, to business meetings, etc., and they can easily be brought on the person of a user substantially anywhere that the user goes.

It is also currently very common for people to exchange contact information with one another. This can conventionally be done in a variety of different contexts, such as in a business or work context, in a leisure context, in a home context, in the context of a group that practices a given hobby, or in other contexts. It is not uncommon for an individual to gather the contact information of a large number of other individuals within a relatively short period of time. For instance, at a single trade show, an individual may gather the contact information for tens or even hundreds of other individuals over the span of several days. Similarly, when on a business trip, an individual may also gather the contact information for a large number of other individuals within the span of several days.

Contact information is conventionally gathered in a number of different ways. For instance, individuals can exchange business cards, and later enter the contact information into a handheld computing device. Similarly, users can manually enter information into a handheld computing device as it is received from another person. Of course, individuals can also download or scan, or otherwise transmit, contact information of another person, from one device to another.

Given the fact that people often gather contact information from a large number of other individuals within a relatively short span of time, and given the ease with which contact information can be entered into a handheld computing device, it is not surprising that individuals accumulate a large amount of contact information on their handheld computing devices. Thus, it can be difficult for an individual to remember who a given set of contact information corresponds to. Alternatively, an individual may remember another person, but not remember that person's contact information. That is, it can be difficult for the user to associate the gathered contact information with a specific individual, later on, when the user is attempting to locate that specific individual. In sum, it can be difficult for a user to remember whose contact information is whose.

Therefore, it is also not surprising that some users often use only a fraction of the contact information that they gather in their handheld computing device. This can lead to contact directories that are overpopulated with useless information, and it can also encumber the user's ability to identify specific, useful contact information, when needed.

### SUMMARY

On a handheld device, a user enters new contact information to create a new contact entry, and a time stamp and geographic location are automatically added to the new contact entry. Therefore, when the user later views that contact entry, the location and time when the user gathered that contact information is noted. This can assist the user in identifying the particular individual represented by the contact entry, or in identifying contact information for the particular individual, or both.

In one embodiment, when a user displays a contact entry, a date is also displayed when the user last contacted the individual represented by the contact entry. Optional information can include the mode of the last contact, and the substantive content of the last contact. Similarly, quick response data can be associated with individuals and used to download contact information.

### BRIEF DESCRIPTION OF THE DRAWINGS

FIGS. 1A-1C are block diagrams of illustrative embodiments of a handheld computing device.

FIG. 2 is a flow diagram illustrating the overall operation of the device shown in FIG. 1A in accordance with one embodiment.

FIG. 3 illustrates one illustrative user interface displaying a contact list.

FIGS. 4 and 5 show illustrative embodiments for receiving contact information.

FIG. 6A shows one illustrative embodiment of a user interface displaying a contact entry.

FIG. 6B is a flow diagram showing one illustrative embodiment for generating a new contact entry.

FIG. 7 is a flow diagram showing one illustrative embodiment for opening and displaying an already-existing contact entry.

FIG. 8 is a user interface display showing one illustrative embodiment of a contact entry illustrating a “Last Time Contacted” field.

FIG. 9 is a flow diagram illustrating one embodiment for inputting contact information, in more detail.

FIGS. 10A and 10B are exemplary user interfaces showing the scanning of a quick response (QR) code in receiving contact information.

FIG. 11 is a flow diagram illustrating one embodiment for performing a mapping function.

FIGS. 12A-12G are user interface displays showing illustrative embodiments of the mapping function.

FIG. 13 is a flow diagram illustrating one embodiment for displaying contact information based on a date range.

FIGS. 14A-14F are user interface displays showing one embodiment of displaying contact entries based on a date range.

FIG. 15 is a flow diagram illustrating the display of contact entries based on date of last contact.

FIGS. 16A-16D are user interface displays showing one embodiment for displaying contact entries based on a date of last contact.

FIG. 17 is a flow diagram illustrating one embodiment of an atlas search function.

FIGS. 18A-18D are user interface displays showing embodiments for displaying contact entries based upon a location range.

FIG. 19 is a block diagram showing one configuration for handheld devices to communicate information with one another.

FIG. 20 is a block diagram showing one illustrative configuration in which handheld devices can communicate with one another, with a server, and with other computing devices.

### DETAILED DESCRIPTION OF ILLUSTRATIVE EMBODIMENTS

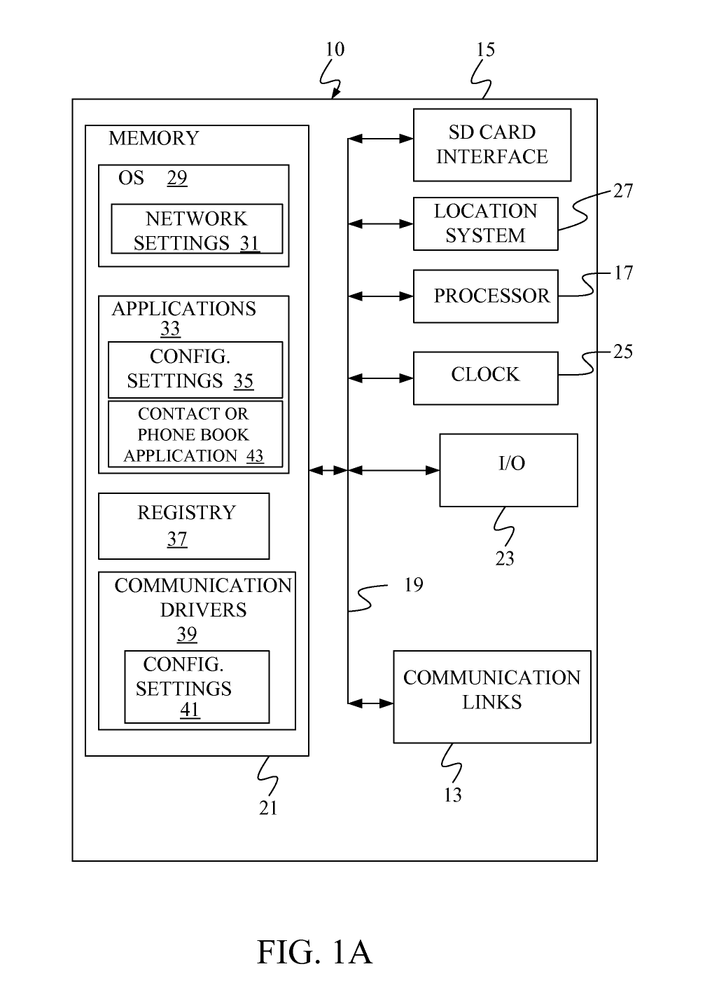

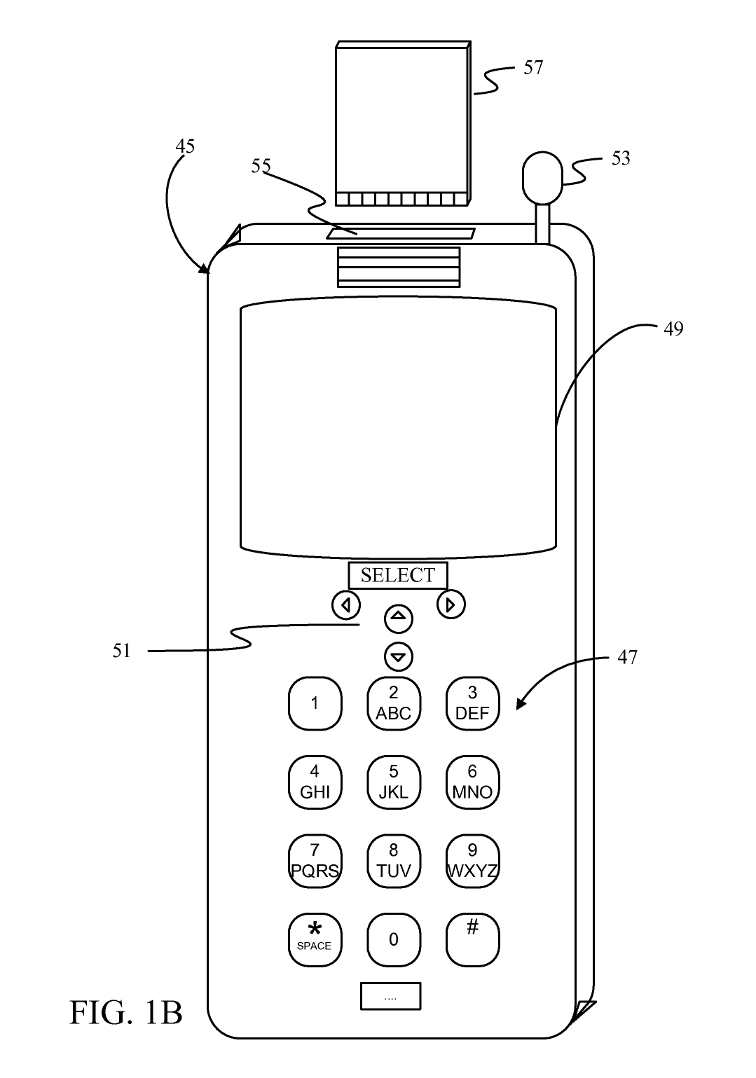

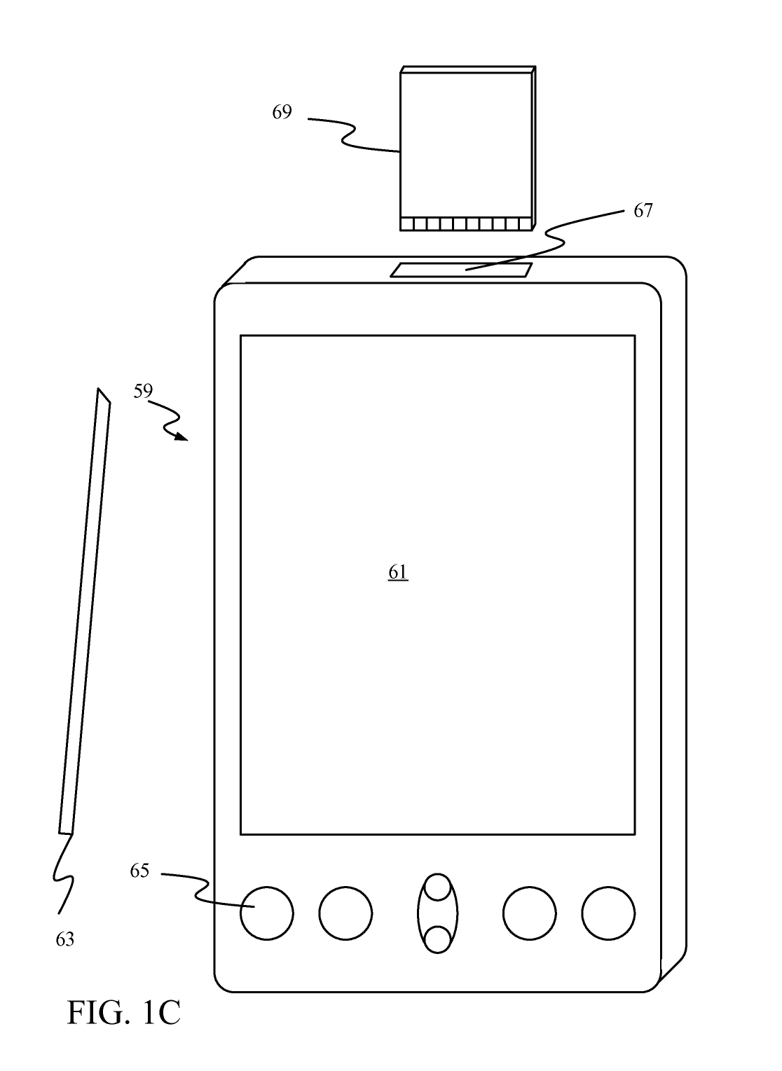

FIG. 1A is a simplified block diagram of one illustrative embodiment of a mobile computing device in which the present system can be deployed. FIGS. 1B and 1C are examples of handheld mobile devices. Before discussing the invention in more detail, FIGS. 1A-1C are described for enhanced understanding.

FIG. 1A provides a general block diagram of the components of a handheld device 10 that runs a phonebook or contacts application. In the handheld device, a communications link 13 is provided that allows the handheld device to communicate with other computing devices and under some embodiments provides a channel for receiving contact information automatically, such as by scanning. Examples of communication links 13 include an infrared port, a link used for image capture, a serial/USB port, a cable network port such as an Ethernet port, and a wireless network port allowing communication though one or more communication protocols including General Packet Radio Service (GPRS), 1×rtt, Orthogonal Frequency—division multiple access (OFDMA), multiple input multiple output (MIMO),and Short Message Service, which are wireless services used to provide cellular access to a network, as well as 802.11 and 802.11b (Wi-Fi) protocols, and Bluetooth protocol, which provide local wireless connections to networks. Of course, these are examples only.

Under other embodiments, the contacts or phone book application is received on a removable Secure Digital (SD) card, or another external memory device, that is connected to a SD card (or other) interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the mobile device can include input components such as buttons, touch sensors, touch screens, proximity sensors, microphones, tilt sensors, and gravity switches and output components such as a display, a speaker, and or a printer port.

Clock 25 can comprise a real time clock component that outputs a time and date. It can also, by way of example, provide timing functions for processor 17.

Location system 27 illustratively includes a component that outputs a current geographical location of device 10. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, registry 37, communication drivers 39, and communication configuration settings 41. Memory 21 can include all types of tangible volatile and non-volatile computer-readable memory devices. Memory 21 stores computer readable instructions that, when executed by processor 17, cause the processor to perform computer-implemented steps or functions according to the instructions.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the handheld device 10 or an external device (such as SD card 57) or applications that are installed during use. In one embodiment, applications 33 include contact or phonebook application 43, although this can be part of operating system 29, or hosted external to device 10, or otherwise remotely such as in a cloud computing architecture, as well.

FIGS. 1B and 1C provide examples of handheld devices that can be used with the present invention, although others can be used as well. In FIG. 1B, a mobile phone 45 is provided as the handheld device 10. Phone 45 includes a set of keypads 47 for dialing phone numbers, a display 49 capable of displaying images including application images, web pages, photographs, and video, and control buttons 51 for selecting items shown on the display. The phone includes an antenna 53 for receiving cellular phone signals such as General Packet Radio Service (GPRS) and 1×rtt, and Short Message Service (SMS) signals (or other signals). In some embodiments, phone 45 also includes a Secure Digital (SD) card slot 55 that accepts a SD card 57.

The mobile device of FIG. 1C is a personal digital assistant (PDA) 59. PDA 59 includes an inductive screen 61 that senses the position of a stylus 63 (or other pointers, such as a user's finger) when the stylus is positioned over the screen. This allows the user to select, highlight, and move items on the screen as well as draw and write. Handheld device 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the handheld devices are possible under the present invention. Examples include tablet or slate PCs, music or video players, and other handheld computing devices.

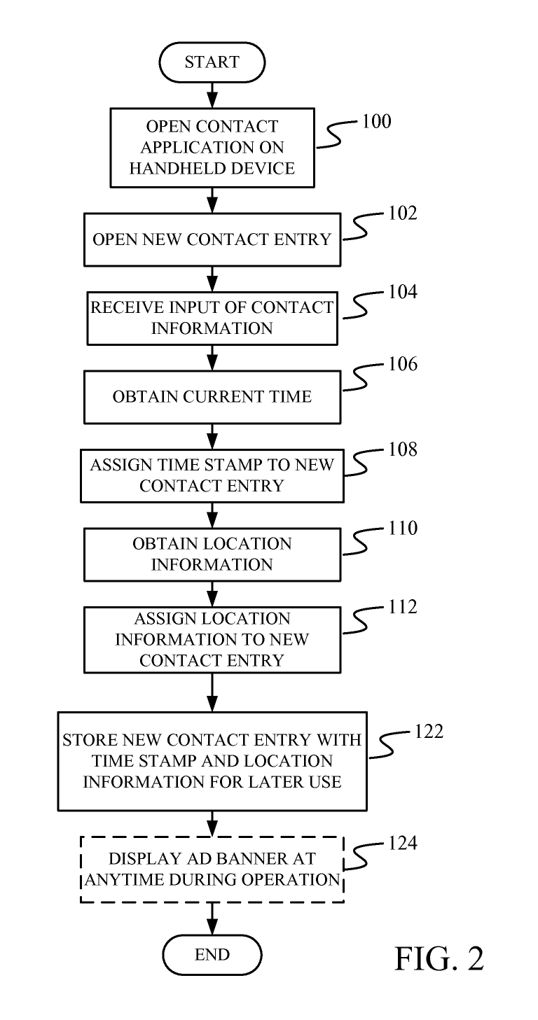

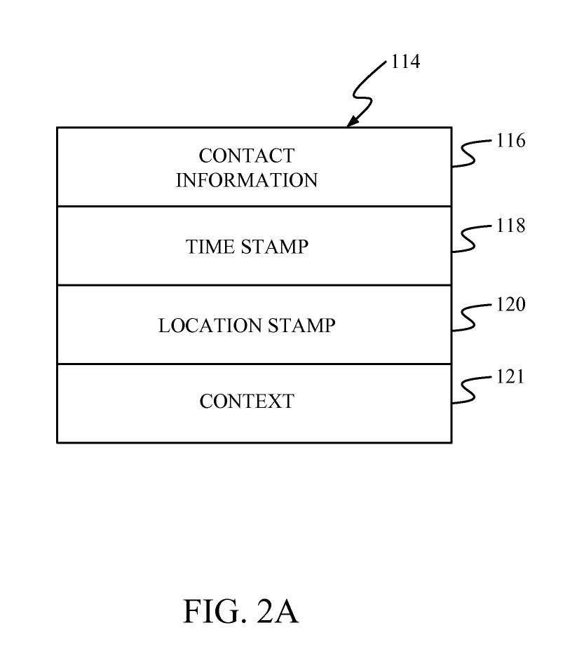

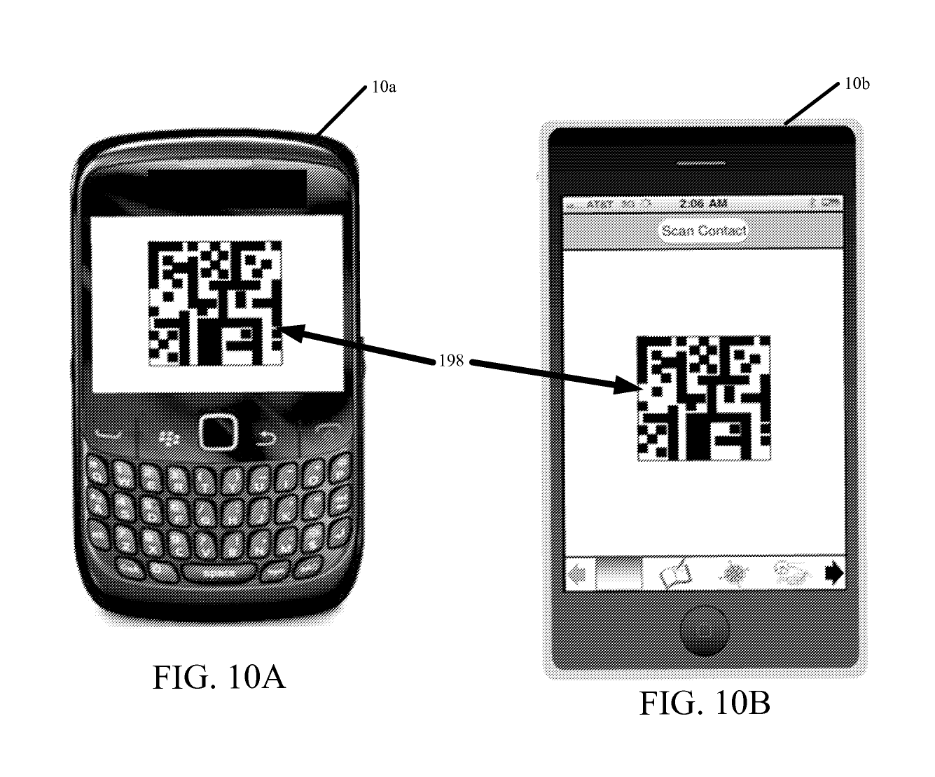

FIG. 2 is a flow diagram illustrating one embodiment of the operation of one handheld device, 10, having the components shown in FIG. 1A, in generating a new contact entry. Some later FIGS., such as FIGS. 10A and 10B show two different styles of a handheld device 10 (and they are labeled devices 10A and 10B). The two are shown by way of example only, and other styles of handheld devices can be used as well. Devices 10A and 10B are collectively referred to hereinafter (for ease of reference) as device 10. Thus, by referring to device 10 hereafter, both devices 10A and 10B (and other handheld and mobile devices) are included. Similarly, even through some FIGS. show only one particular device 10A or 10B, it will be noted that this is exemplary only, and others could be used as well. In one embodiment, when device 10 is turned on, it illustratively includes an icon that is representative of phone book application or contact list application 43 stored on device 10. In an embodiment in which the device includes a touch sensitive screen, a user can normally simply touch the icon and the phone book or contact application 43 opens up. In other devices, the user manipulates a user input device (such as a thumb pad, scroll buttons, actuation buttons, etc.) in order to point to and select the icon, or otherwise open the contact list (or phone book) 43. The particular mechanism by which the user opens the contact list application 43 can vary with application. In any case, the device 10 first receives an input from the user to open the contact list on the handheld device 10. This is indicated by block 100 in FIG. 2.

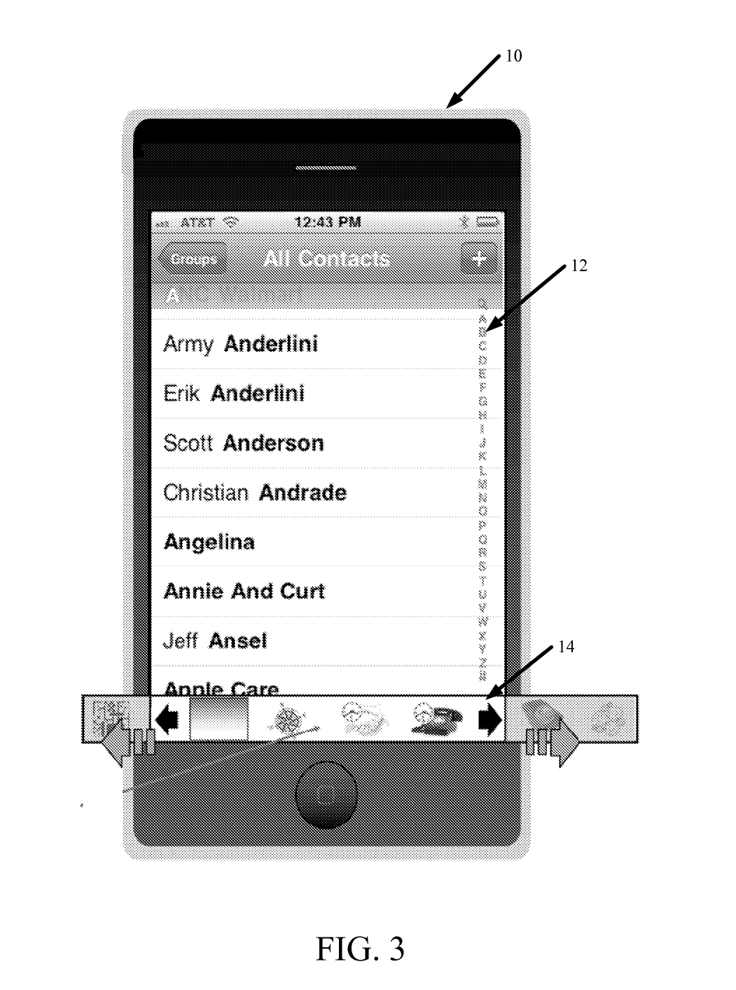

FIG. 3 shows one illustrative embodiment of a user interface generated on device 10 once the contact list has been opened. Of course, the default screen for the application can be a different screen and the one shown in FIG. 3 is exemplary only. As can be seen in FIG. 3, the user interface display not only displays contact entries in alphabetical order, but may illustratively include an alphabetical listing 12 that allows a user to quickly move through the contact list to another portion. For instance, if the user touches one of the letters in list 12, device 10 illustratively displays the contact entries starting with that letter. In addition, in one embodiment, device 10 can include a navigation bar 14 that allows the user to navigate among the various applications on device 10. Navigation bar 14 can be touch sensitive or it can be otherwise accessed by using navigation buttons or other mechanisms.

In any case, once the contact or phone book application 43 is open, in order to add a new contact entry, the user illustratively selects an appropriate user interface element for navigating to a new contact entry screen. This is indicated by block 102 in FIG. 2. In one illustrative embodiment, the user can do this by actuating a menu button on the touch sensitive screen of device 10 or by selecting another menu option using keys or other input devices where the screen is not touch sensitive. Of course, the user can illustratively navigate to a new contact entry screen using other buttons, other than the menu button, as well, and the menu button is mentioned for the sake of example only.

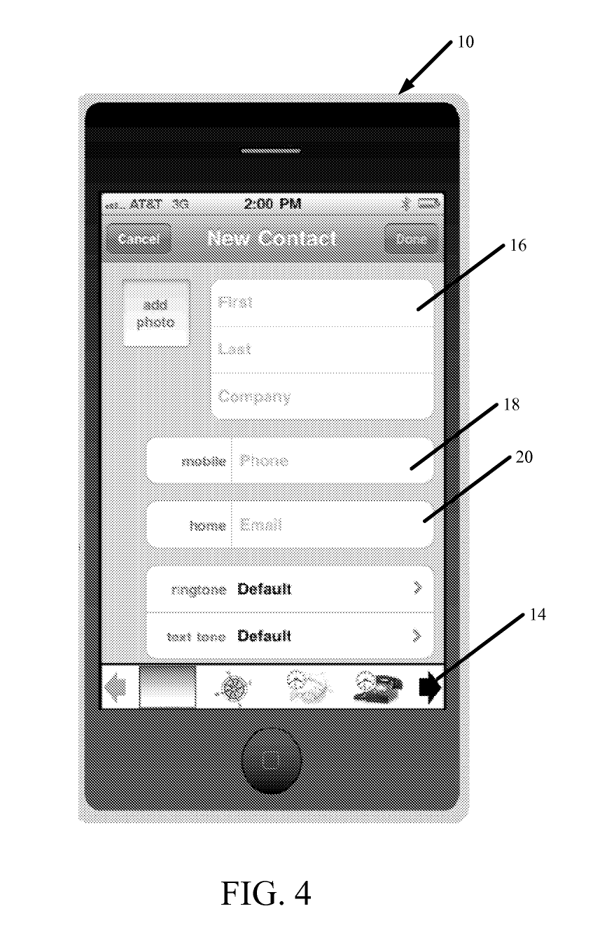

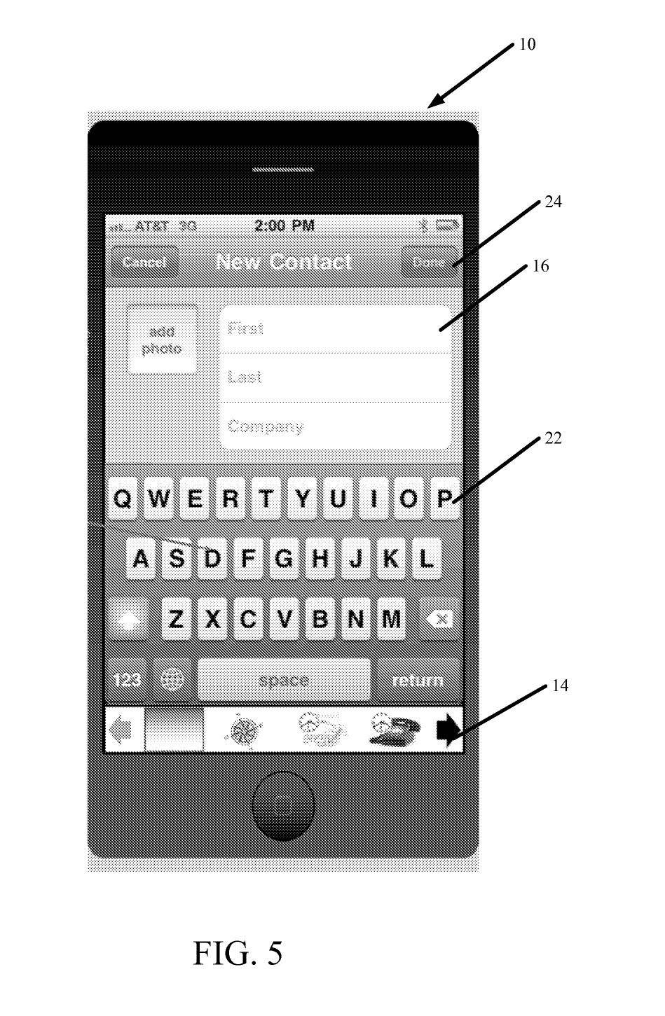

FIG. 4 shows one embodiment of a user interface display generated by device for entry of new contact information. It can be seen in FIG. 4 that a number of text boxes (or fields) 16, 18, and 20 are displayed through which a user can enter text identifying an individual that is the subject of the new contact entry. Of course, different, fewer, or additional fields or input mechanisms can be used as well. If the user touches one of these text boxes, device 10 illustratively displays a touch sensitive keyboard as shown at 22 in FIG. 5. This allows the user to enter text in one of the selected text boxes 16, 18 and 20. In the embodiment shown in FIG. 5, the user has selected text box 16 for entry of textual information. When box 16 is selected, device 10 generates the appearance of a language specific keyboard to receive textual inputs.

Of course, for a device 10 where the screen is not touch sensitive, or where touch sensitive features are not used, the user can illustratively position a cursor or other pointer over a desired text box and select it using a key or other button. In that case, device 10 may illustratively include its own touch sensitive or physical alphanumeric keypad for entry of textual information. The user then illustratively enters the desired contact information and moves on to another field, or presses a “Done” button such as button 24 shown in FIG. 5, indicating that the user has completed entry of the contact information. Receiving input of the contact information is indicated by block 104 in FIG. 2.

When the user has completed entering this information, the processor 17 in device 10 can obtain time information from clock 25 (FIG. 1A) corresponding to a current time and assign a timestamp to the new contact entry, just created by the user. This is indicated by blocks 106 and 108 in FIG. 2. In addition, the processor 17 can obtain location information from location system 27 (FIG. 1A) indicative of a current location of device 10, and assign that location information to the new contact entry that was just created as well. This is indicated by blocks 110 and 112 in FIG. 2. It will be appreciated, of course, that the location information can be any of a wide variety of different types of location information. For example, the location information can include longitude and latitude coordinates obtained by a global positioning receiver on device 10. Of course, other positioning systems, such as Loran, or automated dead reckoning systems, or cellular triangulation can be used as well. In any case, the information illustratively indicates either a current position of device 10, or a user-entered position where the user first met the individual represented by the new contact entry.

FIG. 2A shows one illustrative embodiment of a data record 114 that can be used to store the new contact entry. Data record 114 illustratively includes a contact information portion 116 that includes the particular contact information, such as the contact's first and last name, company, telephone number, email address, etc. Data record 114 also illustratively includes a timestamp portion 118 and a location stamp portion 120 as well as a context portion 121. Timestamp portion 118 illustratively contains the timestamp assigned to the new contact entry 114 by the processor, and location stamp portion 120 illustratively includes the location information assigned to the new contact entry 114 by the processor. Context portion 121 can store a context associated with the new contact entry. The processor then stores the new contact entry 114, along with the time stamp in portion 118, location information in portion 120, and possibly the context portion 121 in a desired memory, for later use. The memory can be memory 21 shown in FIG. 1A or a different memory accessible by processor 17. This is indicated by block 122 in FIG. 2.

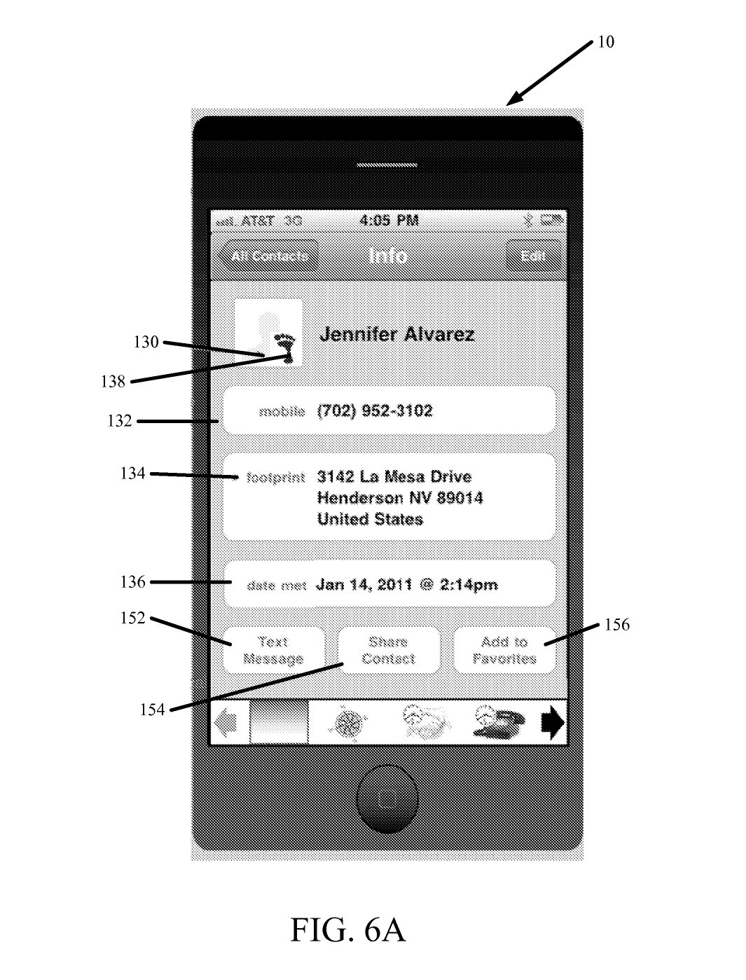

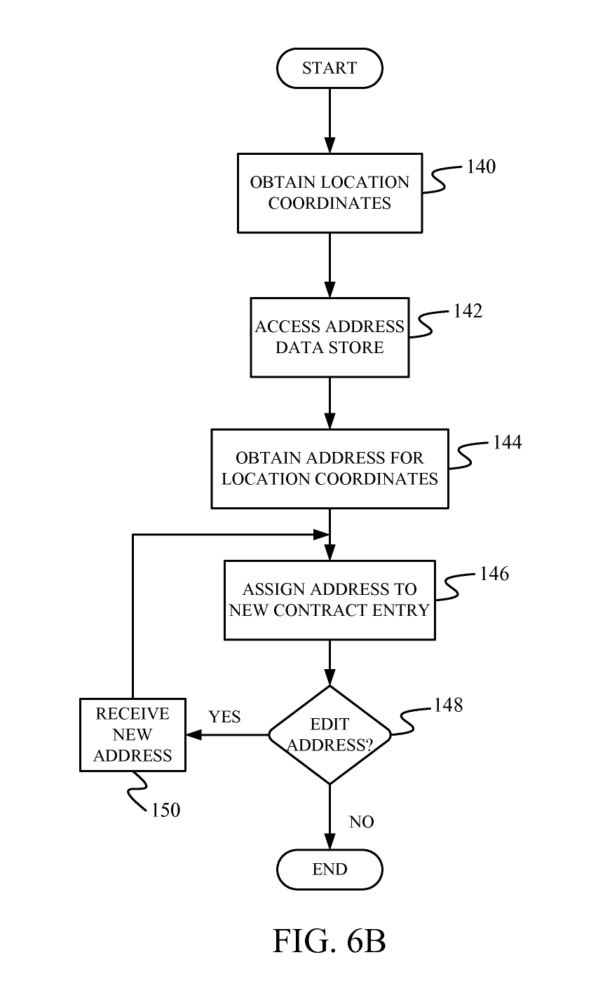

It should also be noted, of course, that the new contact entry can be appended with an identifier that can be displayed to the user, where the identifier indicates that the location and time stamp data has been appended to this contact entry. This is described in greater detail below with respect to FIG. 6A. Further, it should be noted that the contact application 43 can also display advertising in a banner or other display mechanism during its operation. This step is indicated by block 124 in FIG. 2, and it is shown in phantom to emphasize that it is optional.

FIG. 6A shows one illustrative user interface display generated by device 10, that displays a number of items of contact information for a contact entry that has been selected for display by the user. In the embodiment shown in FIG. 6A, the user interface display includes an optional picture display field 130 that can be used to display a photograph or other iconic representation of the individual represented by this contact entry. FIG. 6A also shows that the user interface display includes a telephone number field 132 for displaying the individual's telephone number and a location field 134 for displaying a location where the user of device 10 met the individual represented by this contact entry, or at least where the contact information was input into device 10A by the user. This corresponds to the information in the location stamp portion 120 shown in FIG. 2A.

Similarly, the user interface display of FIG. 6A also includes a timestamp field 136 that includes a timestamp representative of a time when the user of device 10 first met the individual represented by the displayed contact entry, or at least when the contact information was entered into device 10. This corresponds to the information in the time stamp portion 118 shown in FIG. 2A.

It will also be noted that, in accordance with one embodiment, field 130 includes an indicator 138 that is displayed, along with any iconic representation of the individual represented by the displayed entry. The indicator 138 indicates that the present contact entry has been appended with location information 134, or time stamp 136, or both. This enables the user to quickly identify that the present contact entry includes the location where the contact was first met, or the time, or both.

FIG. 6B is a flow diagram illustrating one embodiment of the operation of device 10 in obtaining the location information appended to the contact entry and displayed in field 134, when a new contact entry is generated. In one embodiment, device 10 first obtains the location coordinates (or other location information that identifies a current position) from some type of positioning or location system 27 described above with respect to FIG. 2. This is indicated by block 140 in FIG. 6B.

The processor of device 10 then illustratively accesses an address data store that stores addresses of locations indexed by the location coordinates or other location information. This is indicated by block 142 in FIG. 6B, and can be a portion of memory 21 or a different memory accessible by processor 17. Once the processor 17 has looked up the address (if one exits) corresponding to the current location information, the processor appends the address to the new contact entry as the location stamp in portion 120 (shown in FIG. 2A). This is indicated by blocks 144 and 146 in FIG. 6B. Of course, when the user is entering the new contact entry, or when the user later calls up that contact entry for display (as shown in FIG. 6A), the address is displayed in address box 134. It should also be noted that, in one exemplary embodiment, while the derived address can be displayed to the user, the underlying location coordinates (or other location information) obtained from location system 27 can still be used for other processing described herein.

In one illustrative embodiment, when the user selects address box 134, the user can edit that address as well. This is indicated by blocks 148 and 150. If a new address is input by editing, then the new address is assigned to the new contact entry and stored. This is indicated by reverting to the processing at block 146 in FIG. 6B. In another embodiment, the user can assign multiple address entries to a single contact entry.

The user interface display shown in FIG. 6A illustrates a number of other optional features as well. For example, the user interface display includes a “Text Message” function key 152, a “Share Contact” function key 154 and an “Add To Favorites” contact key 156. Key 152 can be used to quickly navigate to a text messaging interface that allows the user of device 10 to generate and send a text message to the individual represented by the contact entry currently being displayed. The Share Contact button 154 allows the user to share the presently displayed contact information with another user of another device 10, or in any other desired way. Button 156 allows the user of device 10 to add the present contact information to a list of favorite contacts that can be displayed as well.

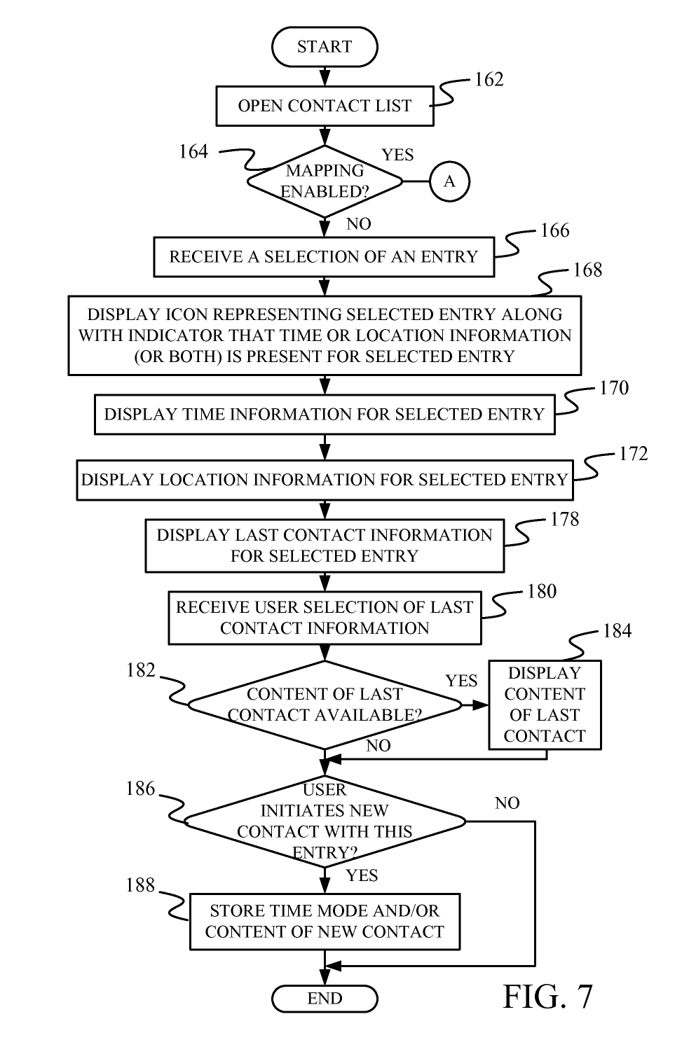

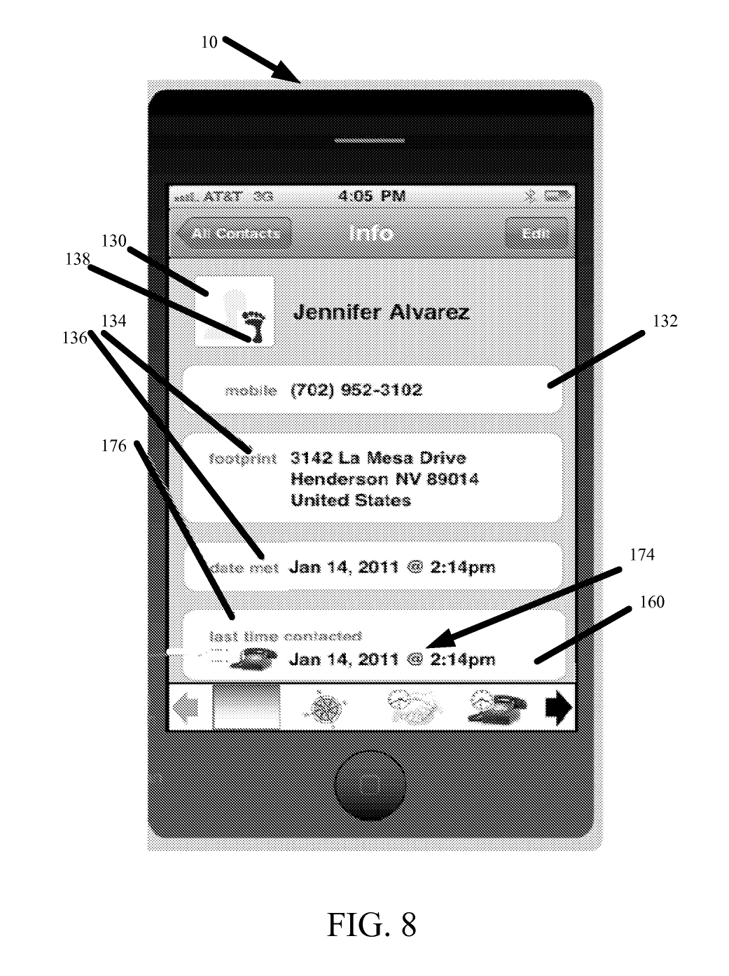

FIG. 7 is a flow diagram illustrating one exemplary embodiment of the operation of device 10 when a user opens an already-existing contact entry. FIG. 8 is one illustrative user interface display generated when that contact entry is opened. A number of the items on the user interface display of FIG. 8 are similar to those shown on FIG. 6A, and are similarly numbered. As will be described below, however, the user interface display of FIG. 8 also illustratively includes a “Last Time Contacted” field 160.

The operation shown in FIG. 7 starts by device 10 receiving an indication from the user to open the contact or phonebook application 43. This is indicated by block 162 in FIG. 7 and can simply be represented by the user touching an icon on a touch sensitive screen representative of the contact list, or otherwise actuating a button or somehow selecting the application 43 for opening.

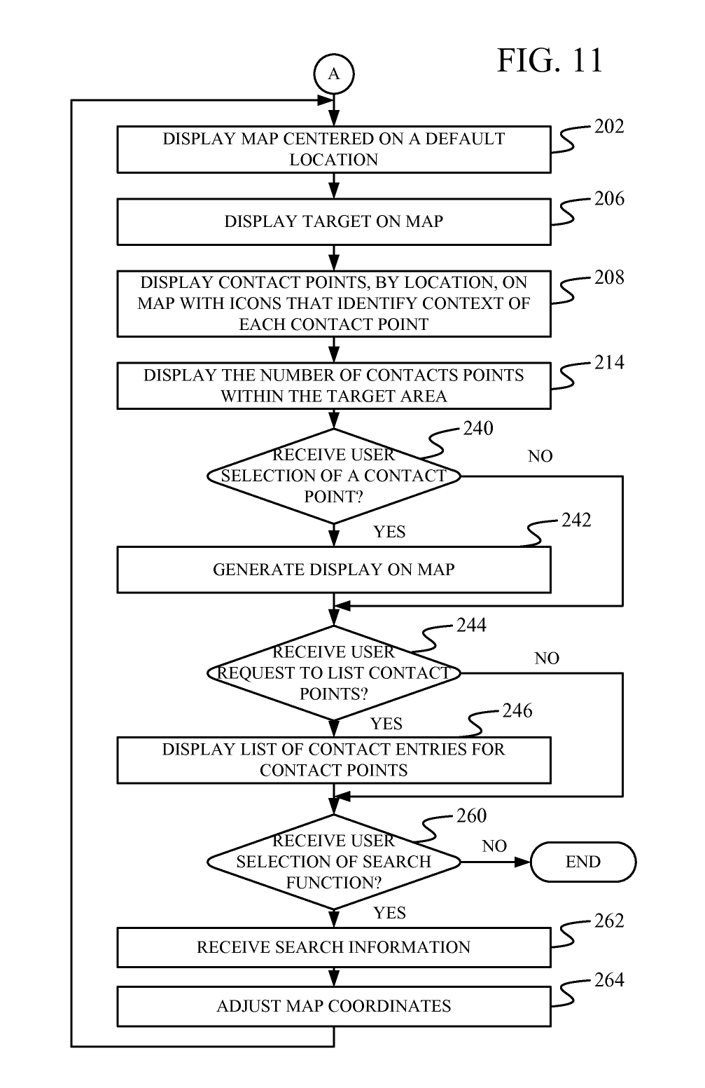

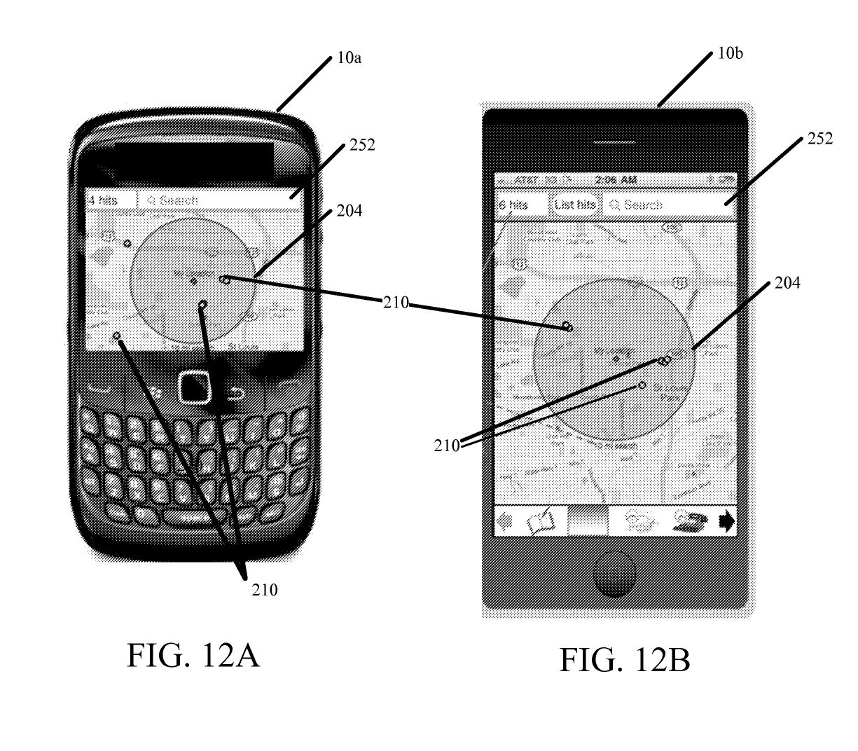

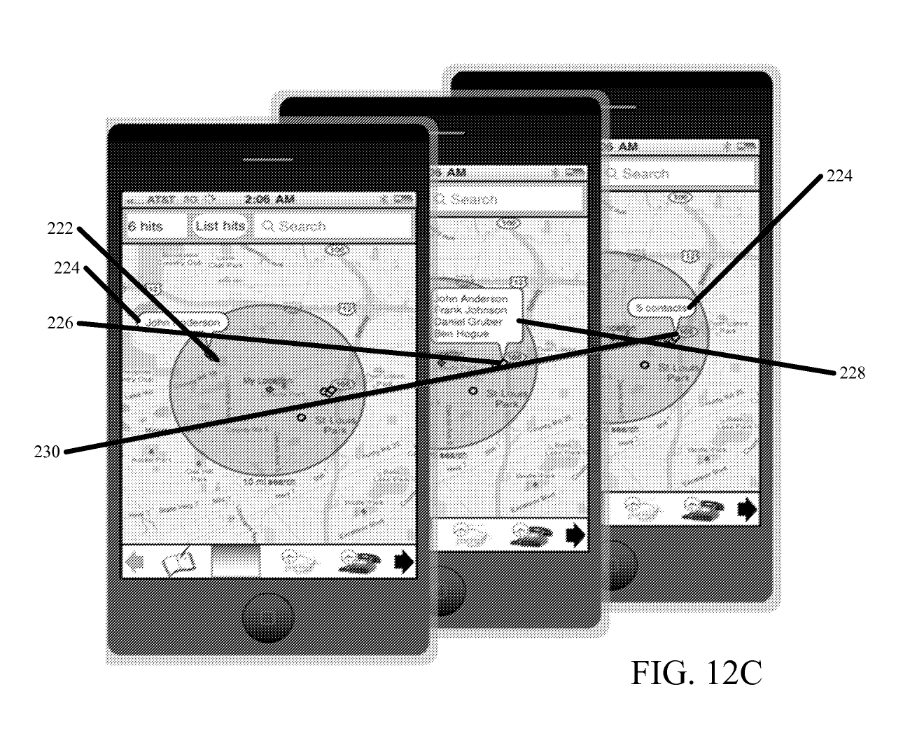

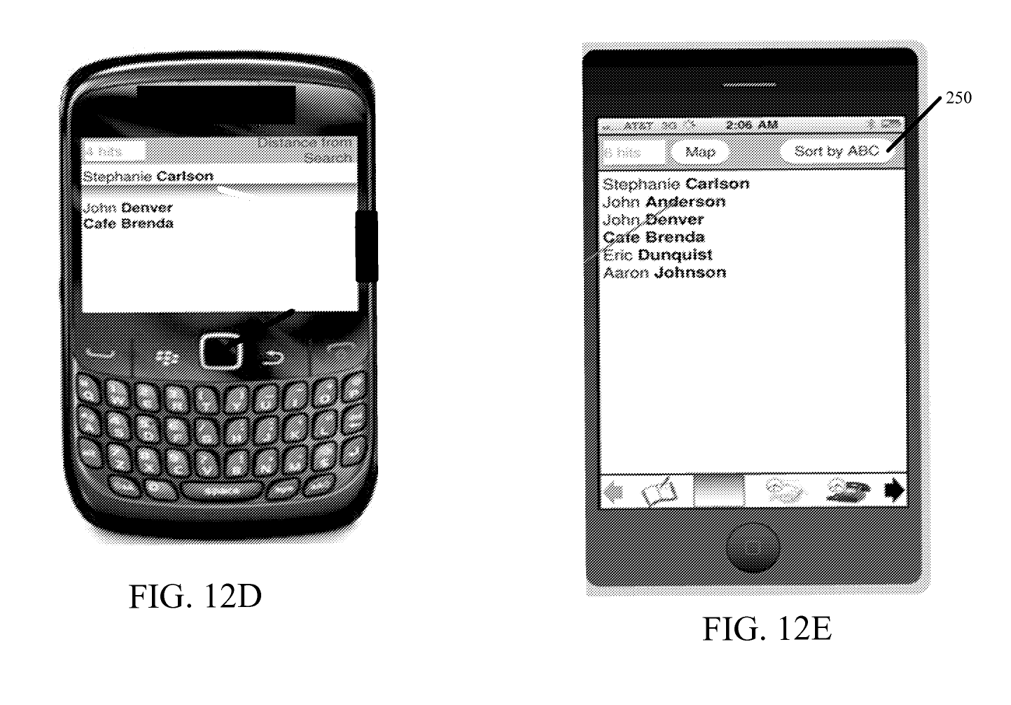

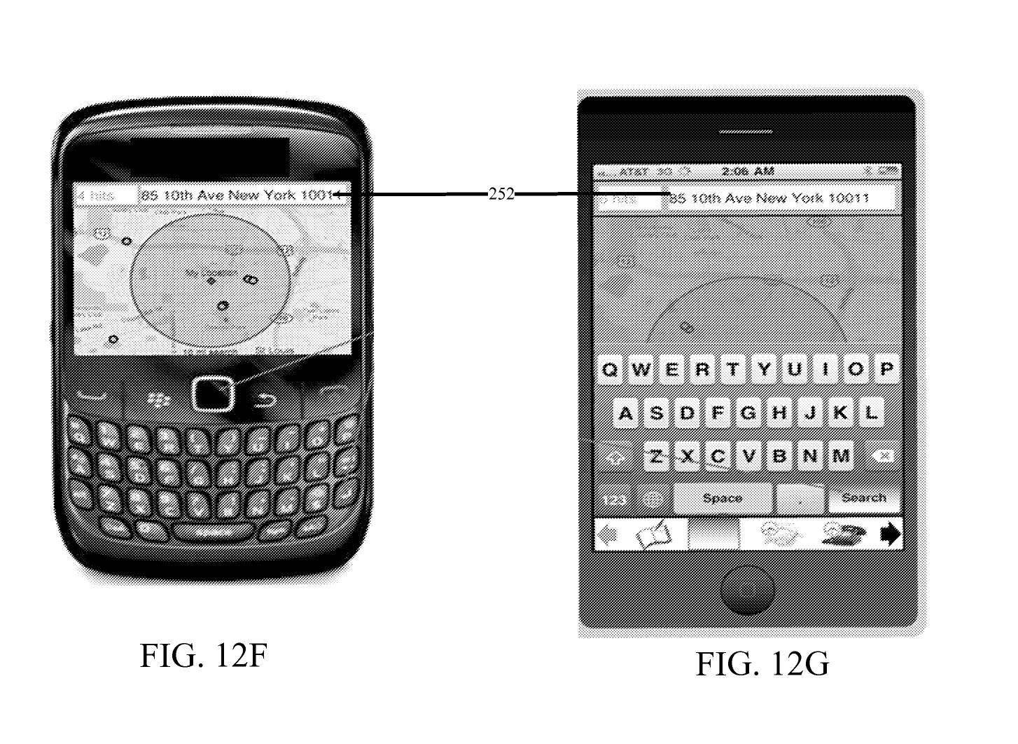

After the application is opened, device 10 determines whether location information viewing functionality is selected. Location information viewing functionality is described below with respect to FIGS. 11-12G and shows an alternative way for a user to view contacts. Determining whether this functionality is selected is indicated by block 164 in FIG. 7. If so, processing jumps to FIG. 11 (which is described below). If not, however, then device 10 generates a user interface (such as that shown in FIG. 3) which lists contact entries in the contact or phonebook application 43, and receives a user input indicative of the user selecting one of those contact entries. This is indicated by block 166 in FIG. 7.

Device 10 then generates a display, such as that shown in FIG. 8. In the exemplary display of FIG. 8, device 10 displays the icon 130 and indicator 138 indicating that time or location information (or both) has been appended to the selected entry. This is indicated by block 168 in FIG. 7. Device 10 also displays conventional contact information, such as the contact's name, phone number(s), etc.

In addition, device 10 displays the time information for the selected entry and the location information for the selected entry. This is indicated by blocks 170 and 172 in FIG. 7. The time information is illustratively shown in the “Date Met” field 136 and the location information is illustratively shown in the location field 134 in the display shown in FIG. 8.

In one embodiment, device 10 also displays information in “Last Time Contacted” box 160 that is representative of the last time that the subject of the present contact entry was contacted by the user. For instance, in the example shown in FIG. 8, the display in box 160 includes a time display portion 174 and a mode display portion 176. The time display portion 174 displays the time that the subject was last contacted, and the mode display portion 176 displays a mode by which the contact was made. In the embodiment shown in FIG. 8, the mode is a telephone, indicating that the last contact was a telephone discussion or message. Of course, mode indicator 176 could include an indicator representative of a text message, an electronic mail (email) message, etc. Displaying the contact information for the selected entry in block 160 is indicated by block 178 in FIG. 7 (and at 176 in FIG. 8). All of the last contact information can be stored by appending it to record 114 (FIG. 2A) for this contact entry, or it can be stored separately.

If the user selects the Last Time Contacted box 160 (such as by touching it on a touch sensitive screen or otherwise selecting it using actualable buttons, etc.), device 10 determines whether the content of the last contact is available. This is indicated by blocks 180 and 182 in FIG. 7. For instance, if the last contact was a text message, and the substantive content of that text message (such as the message body) was saved in a data store accessible by device 10, then device 10 displays the content of the last contact. Similarly, for instance, if the last contact was a voicemail and the voicemail message was transcribed by a speech recognition engine and stored in an accessible data store, the content of the voice message can be displayed. Of course, if the contact was by email, and the content of the email is stored in an accessible data store, then the content of the email can be displayed as well. Displaying the substantive content of the last contact is indicated by block 184 in FIG. 7. Of course, if the data associated with the last contact is not accessible by device 10, then a suitable message can be displayed such as “data not accessible” or any other suitable indication can be provided to the user of device 10.

If the user then initiates another contact, with the presently displayed contact entry, then the time of that contact, the mode and the content (if available) is stored (such as by appending it to record 114 in FIG. 2A) so that it can be displayed with respect to field 160 when the contact entry is later selected for display by the user of device 10. This is indicated by blocks 186 and 188 in FIG. 7.

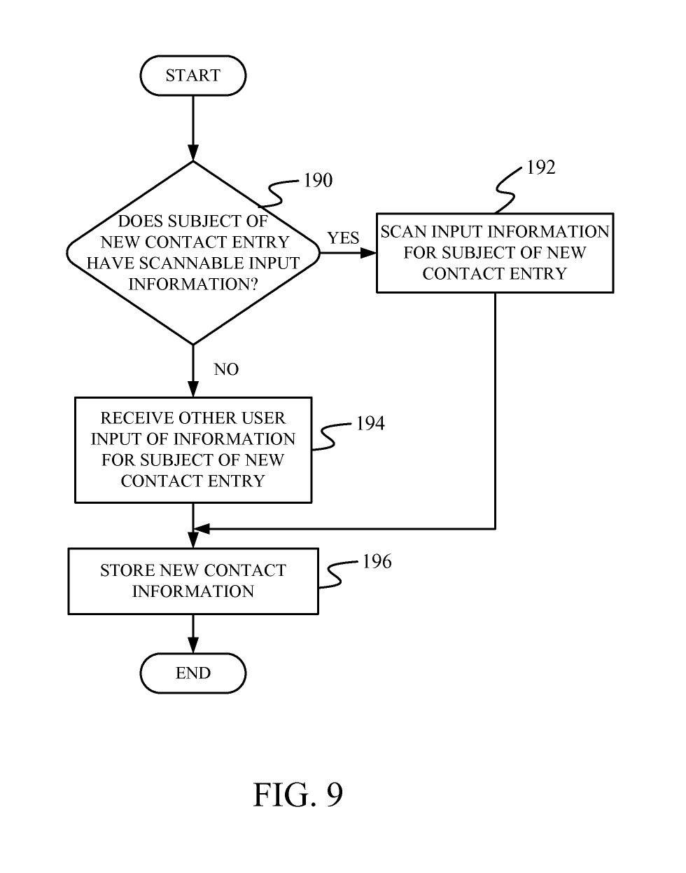

FIG. 9 is a flow diagram illustrating one embodiment of the operation of device 10 in receiving contact information from the user in more detail. A quick response (QR) code is a code that has an associated navigable link that navigates to a predefined destination or executes a predefined command, when the QR code is read by a QR code reader or scanner. In the embodiment discussed with respect to FIGS. 9, 10A and 10B, I/O components 23 of device 10 is illustratively equipped with a QR code scanner or reader. Also, in that embodiment, each of the contacts is illustratively associated with one or more QR codes. When one of the QR codes is scanned or read by device 10, device 10 navigates to a location where the contact information associated with the QR code is electronically stored for download or transfer to device 10.

When the user desires to input contact information into a new contact entry, device 10 first determines whether the subject of the new contact entry has scannable input information. This is indicated by block 190 in FIG. 9. While a QR code is but one form of scannable contact information, others exist as well. For instance, some handheld devices offer text recognition which allows the device to scan a user's business card, recognize the text in the business card and populate the new contact entry with the appropriate information. Other devices can offer barcode scanners. Thus, any type of scannable contact information can be used. If the scannable contact information is available, device 10 scans the input information for the subject of the new contact entry and stores it accordingly. This is indicated by block 192 in FIG. 9. Of course, if no scannable information is available, then device 10 simply receives other forms of input of information for the subject of the new contact entry. This can be manual user input as described above, or using other mechanisms. This is indicated by block 194 in FIG. 9. In either case, the information is stored. This is indicated by block 196 in FIG. 9.

FIGS. 10A and 10B show a user interface display of a QR code 198 corresponding to the subject of the new contact entry. In one embodiment, that individual can manipulate a device (such as device 10) to display his or her QR code on the user interface display of device 10. Then, the user of device 10 who is setting up the new contact entry can manipulate his or her device 10 to scan the image shown on the subject's user interface display, in order to scan in the QR code associated with the subject of the new contact entry. This causes the device that scanned the QR code to navigate to the subject's contact information and download it for storage in the new contact entry in the contact application 43 of the device 10 used by the user who is generating the new contact entry.

FIG. 11 is a flow diagram illustrating the operation of device 10 in employing a mapping function which allows the user of device 10 to locate a given, already-existing, contact entry in an alternative way, instead of simply browsing through an alphabetical list of contact entries. For instance, it may be that the user remembers where he or she met the subject of the desired contact entry, but does not remember the subject's name or company name. In that case, it is helpful for the user to be able to input a geographic location, and identify the various contact entries that correspond to that geographic area. Therefore, in accordance with one embodiment, device 10 first obtains a geographic location as an input. This can be the device's current location, or a location input by the user. Once the location is obtained, device 10 displays a map centered on the input location. This is indicated by block 202 in FIG. 11. FIGS. 12A and 12B show two different representative displays of a map. The center of the map identified as “my location” in FIGS. 12A and 12B is the location entered by the user or the device's current location automatically obtained from location system 27. The device 10 displays a target area 204 on the map, where the target area is centered around the geographic location (such as the “my location” coordinates) shown in FIGS. 12A and 12B. Centering the target on the map is indicated by block 206 in FIG. 11.

Device 10 then displays contact points, based on their location, on the map displayed on the user interface displays of FIGS. 12A or 12B. The contact points are represented by icons 210 that illustratively identify the context of the contact entry corresponding to each contact point. For instance, the contact point may be associated with a “work” context, with a “home” context, with a “hobby” context, etc. This indicates that the subject of a contact entry corresponding to a displayed contact point is known through the user's work, home, hobby, etc. This context information can be entered by the user when a new contact entry is created (as context portion 121 of record 114 in FIG. 2A) or it can be added later, or generated automatically based on time of day, geographic location or otherwise.

In one illustrative embodiment, the icons on the display are shaped or colored, or otherwise displayed, to visually contrast contexts so that the user can quickly identify each contact point and its associated context. In one embodiment, a “work” context is plotted by a gray icon while a “home” context is plotted by a green icon. Of course, other icons can be used as well. Displaying the contact points on the map is indicated by block 208 in FIG. 11.

In one embodiment, the display also includes a “Hits” field such as field 212 in FIGS. 12A and 12B. The Hits field illustratively displays the number of contact points that are located within target area 204, although contact points that are on the map shown on the display, but outside target area 204, can be displayed on the map, but are illustratively not included in the Hits field 212. Displaying the number of contact points within the target area 204 is indicated by block 214 in FIG. 11.

Based on the user interface display shown in FIGS. 12A and 12B, the user can do a number of different things. For instance, if the user selects one of the contact points displayed on the map, then device 10 generates a display, still on the map, but that includes further information. As an example, FIG. 12C shows a number of different user interface displays that are generated based on which specific contact point the user has selected. In one embodiment shown in FIG. 12C, the user has selected contact point 222. Because the contact point 222 represents only a single contact, device 10 simply displays the name of the contact (or other contact information) in a popup or bubble field 224 that is visually connected to, or associated with, the contact point selected by the user. However, if the user selects a contact point 226 whose icon represents 2, 3 or 4 (for example) contacts at the same location, then device 10 displays a list of the names (or other contact information) associated with the contact entries represented by that icon in a bubble field 228 that is again visually associated with the icon.

At some point, when the number of contacts at one location, represented by a single icon, exceeds a predetermined number (such as 5, for example) then device 10 simply generates a different type of display. For instance, where the user has selected contact point 230 (which represents 5 contacts) device 10 simply generates a bubble 232 that textually indicates the number of contacts represented by that icon. This embodiment may occur, for example, when a user meets a large number of people, all of whom are at the same location, such as a tradeshow. It may, of course, occur under other circumstances as well.

When the user selects a popup box or bubble for displaying the contact entries associated with that contact point, these can be displayed in a number of different ways. FIGS. 12D and 12E illustrate two ways for displaying the contact entries. Both FIGS. 12D and 12E show that the contact entries associated with the target area 204 are displayed in a list, sorted by the distance that contact entries are located from the initial coordinates (the center of target area 204). In one embodiment, the user of device 10 can sort the contact entries using other techniques as well. For instance, in the embodiment shown in FIG. 12E, the user can select “sort by ABC” button 250 and the contact entries listed will be sorted in alphabetical order, instead of by geographic distance from the center of target area 204. Of course, other sorting techniques can be used as well. Receiving user selection of a contact point and generating a display on the map is indicated by blocks 240 and 242 in FIG. 11, respectively. Receiving a user selection of the bubble or popup box 224 and listing the contact entries associated with that block is indicated by blocks 244 and 246 in FIG. 11, respectively.

The user interface displays in FIGS. 12A and 12B also show that, in one exemplary embodiment, a search box 252 is included. This allows the user to enter search criteria for searching based on different coordinates. In the embodiments shown in FIGS. 12F and 12G, the user has entered text in search boxes 252 indicating a new address. In that case, system 10 illustratively accesses a reverse geocoding database to find the geographic coordinates of the address input by the user in search box 252, and redraws the map and target area 204, displaying contact points on the new map. Receiving an input indicative of the user's desire to use search box 252, receiving the search information, and adjusting the map coordinates are indicated by blocks 260, 262, and 264 in FIG. 11. Processing then returns to block 202 where the map is centered around the desired location and the target is displayed on the map as are the contact points, etc.

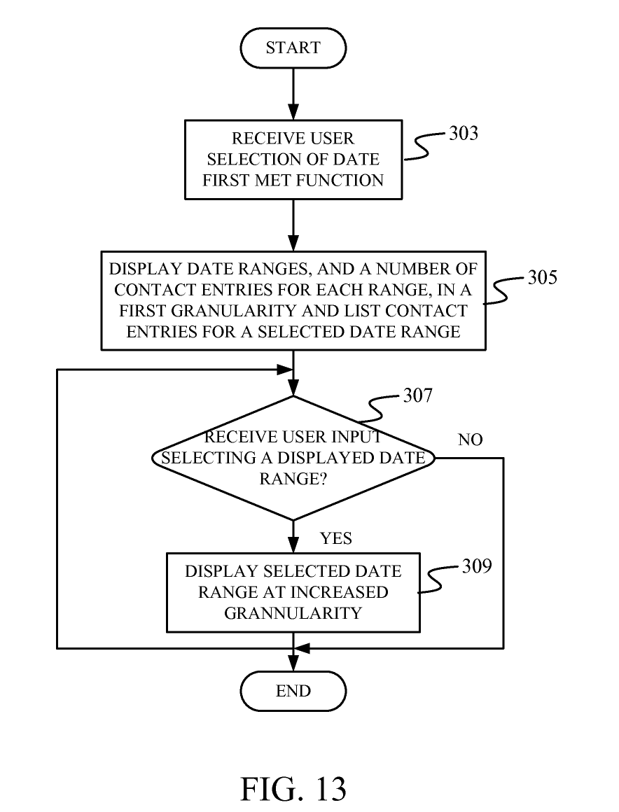

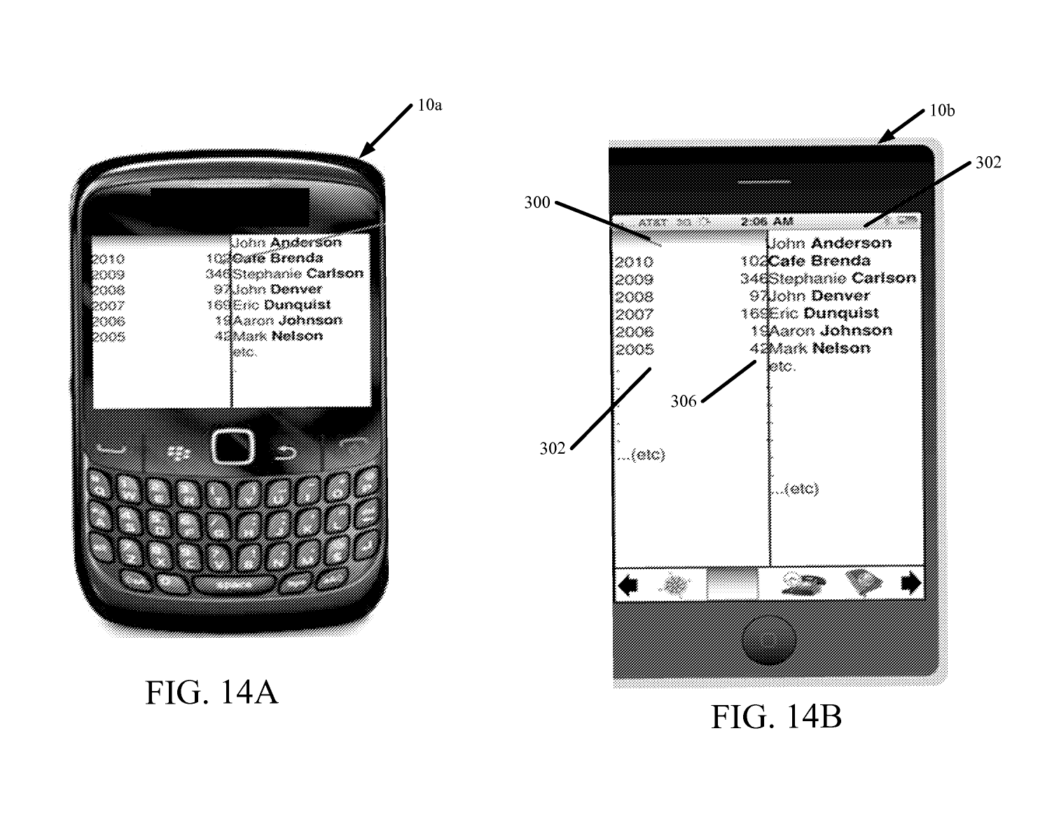

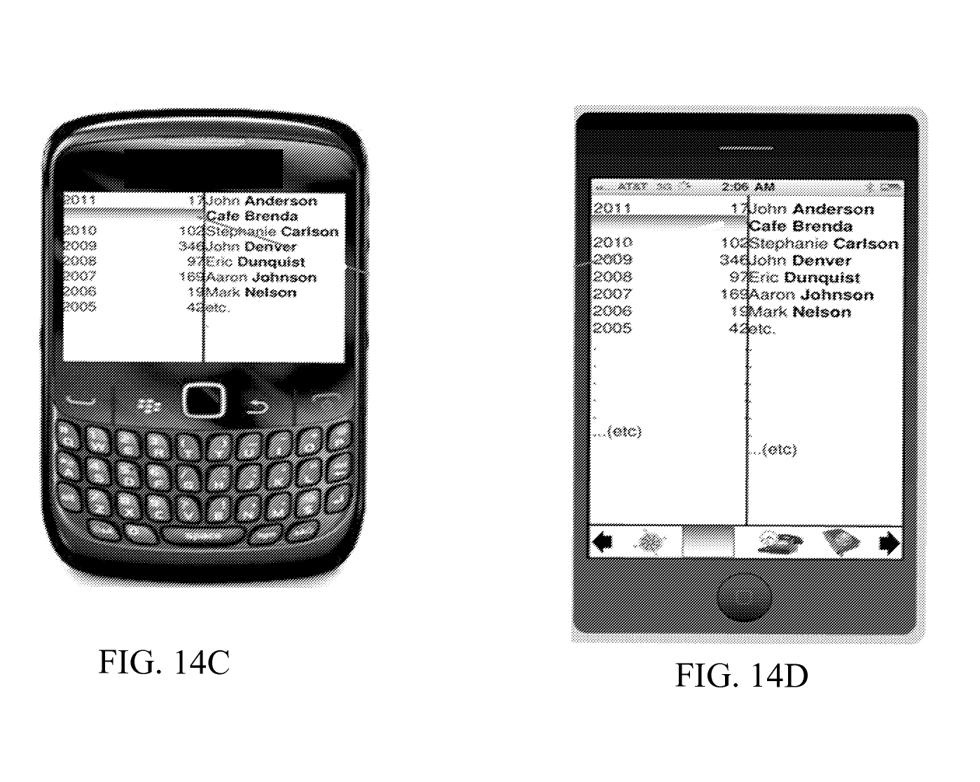

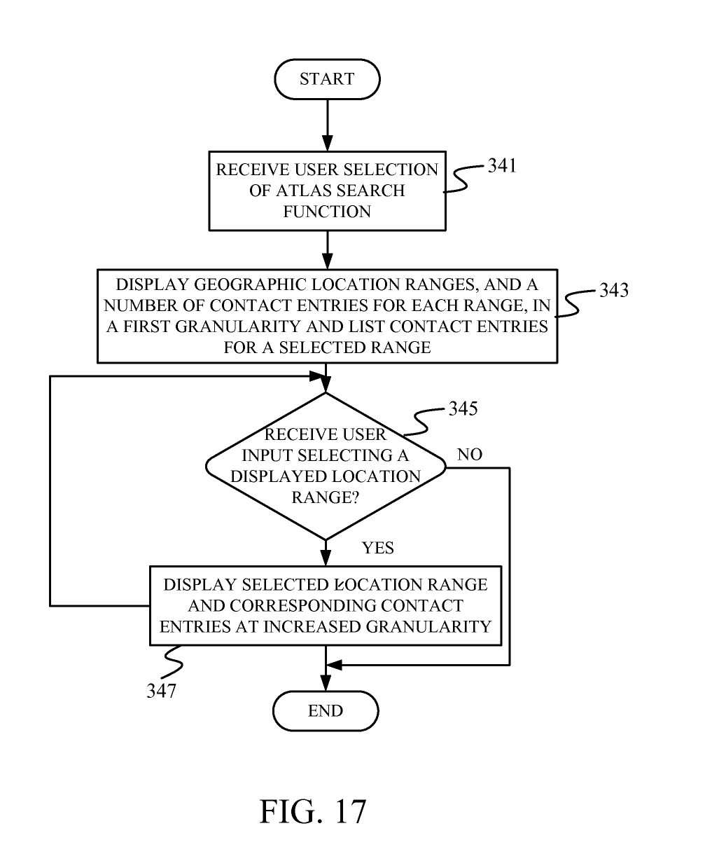

FIG. 13 is a flow diagram illustrating one embodiment of the operation of device 10 in sorting contact entries by the date the contact entry was first entered (e.g., by the “Date First Met”). FIGS. 14A-14F are illustrative user interfaces showing two different embodiments of user interfaces generated by devices during the operation shown in FIG. 17. Again, the two exemplary embodiments of devices 10A and 10B will collectively be referred to as device 10.

The user first selects this function, such as through a dropdown menu or by selecting it through other user interface buttons. This is indicated by block 303 in FIG. 13. When that happens, device 10 displays two columns, a left column 300 and a right column 302. Left column 300, itself, includes two columns 304 and 306. Column 304 displays date ranges in a first granularity (such as a year), and column 306 displays the number of contact entries generated during each date range in column 304. It can be seen in FIGS. 14A and 14B that the year “2011” is highlighted in column 304. In that case, column 302 displays the names of contacts generated in the highlighted year (such as in alphabetical order or by date order or by location or otherwise). In one illustrative embodiment, both lists 300 and 302 are scrollable through an appropriate user interface, such as by the user touching a touch sensitive screen, or by using a scroll pad or scroll bar or scroll buttons, etc. Displaying contact entries of date range, in a first granularity, is indicated by block 305 in FIG. 13.

FIGS. 14C and 14D illustrate that the user can select, through the user interface, to display a certain one of the date ranges in column 304 with a more fine granularity. This is indicated by block 307 in FIG. 13. For instance, if the user selects the year “2011” (by touching it on a touch sensitive screen or by scrolling to it with a pointer and clicking on it or by using another user input mechanism) then device 10 displays the contacts for the year 2011 in a date range having a more fine granularity. In the embodiment shown in FIGS. 14C and 14D, device 10 generates a display showing the contacts for the year 2011 broken out by month. In the exemplary embodiment, only the months with positive data (e.g., with a contact entry within the selected year) are displayed and FIGS. 14C and 14D show that all 17 contacts for the year 2011 were entered during the month of January. Displaying the selected date range and corresponding contact entries at a more fine granularity is indicated by block 309 in FIG. 13.

FIGS. 14E and 14F show that the user can further adjust the granularity by selecting the month “January”. This causes device 10 to display the contacts according to an even more fine granularity. FIGS. 14E and 14F show that, if the user selects the month “January”, then the specific days within the month of January are displayed, along with the number of contacts entered on each day. In the exemplary embodiment shown in FIGS. 14E and 14F, it can be seen that the 17 contacts entered during the month of January, 2011, were entered on the 1^{st}, the 12^{th}, and the 19^{th} of January. The corresponding number of contacts generated on each of those days is also listed in column 306. It can also be seen that January 1^{st} is highlighted, so column 304 displays the contacts, in alphabetical order, that were entered on January 1^{st} or chronologically or alternating between chronological and alphabetical ordering. The contact list 302 is also illustratively sortable based on other criteria (such as the time of the contact or place of the contact, etc.).

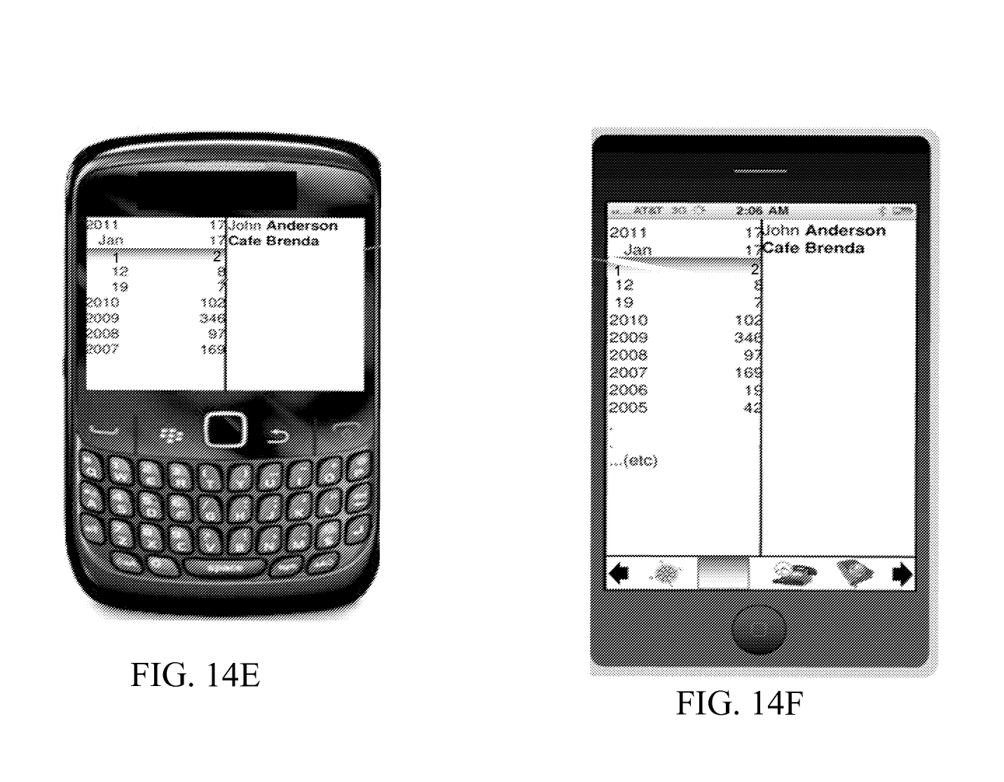

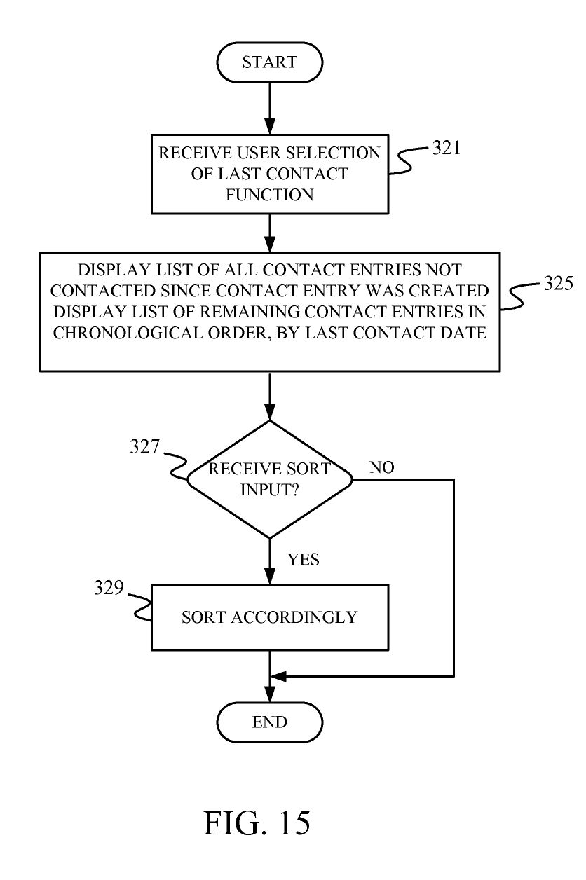

FIG. 15 is a flow diagram illustrating how device 10 can be operated to display contacts in the contact list based on the date of the last communication with the given contact entry. In one illustrative embodiment, the user selects this function through an appropriate menu, such as a dropdown menu or in another suitable manner through the user interface mechanisms of device 10. Receiving user selection of the last contact function is indicated by block 321 in FIG. 15.

Once the function is selected, device 10 illustratively displays two columns 350 and 352. Column 350 displays the date of the last communication, in reverse chronological order, and column 352 displays the name of the contact that was contacted on that date. For contacts in column 352 that do not have any information in the “Last Contacted Date” field, column 350 shows that the date field is left blank, or is populated with a hyphen, or is marked in some other way to show that there has been no contact with the individual subject of the contact entry (or that information is unavailable) since the contact entry was first entered in device 10. In the illustrative embodiment, those contact entries (where no subsequent contact has been made) are listed first. Displaying contact entries with no last contact information and then displaying the other contact entries sorted by last contact date is indicated by block 325 in FIG. 15.

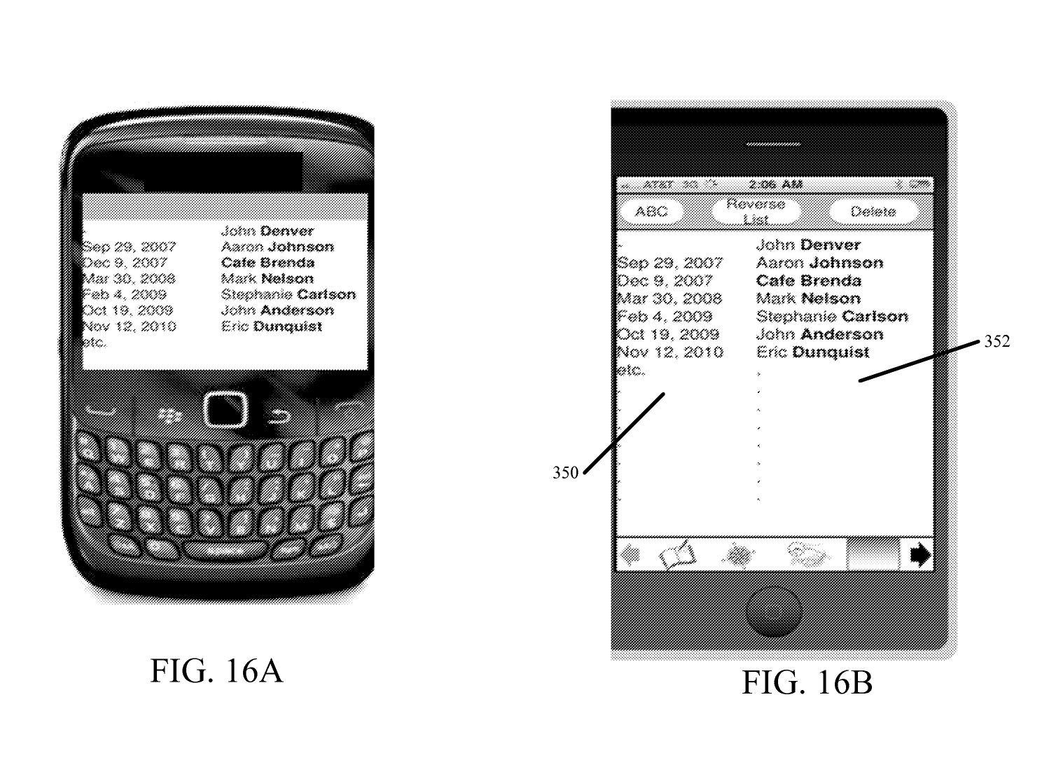

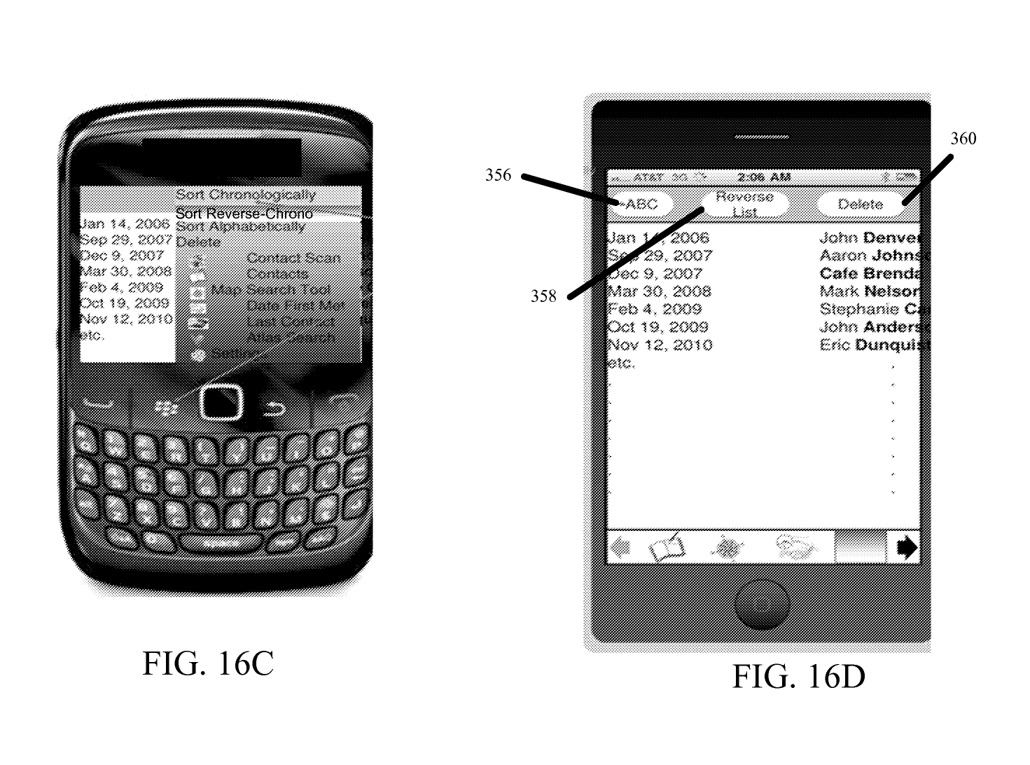

It will be noted that while the contact entries are listed in FIGS. 16A and 16B in reverse chronological order, they could be listed in other ways as well. However, listing the contact entries based on last communication, in chronological order beginning with the oldest first, may be desirable by some users. This first shows the contacts that have never been contacted and then shows those that have only been last contacted a long time ago. This allows users to delete old and unused affiliations from the contact list. It will be noted that, in one embodiment, the last communication function will populate contacts from all synchronized modes of communication, such as email accounts, as well as modes of communication generated from device 10, itself. It should also be noted, in one embodiment, multiple contiguous contacts can be selected simultaneously by engaging a multiple selection tool (such as holding a shift button and scrolling) through the contact list 350 or 352.

FIGS. 16C and 16D illustrate that, in one embodiment, the list in columns 350 and 352 can be sorted and manipulated through the user interface, in a relatively easy way. For instance, FIG. 16C shows that, on some phone platforms, when a menu button is selected, the user can select to sort the list chronologically, in reverse chronological order, alphabetically, or the user can delete a contact entry or a set of selected contact entries. FIG. 16D shows that device 10 includes a plurality of buttons 356, 358, and 360. Button 356 resorts the list in alphabetical order, while button 358 reverses the order of the list and button 360 allows a contact entry to be deleted very easily. Of course, these user interface elements are illustrative only. Receiving a sort input and re-sorting the list are indicated by blocks 327 and 329, respectively.

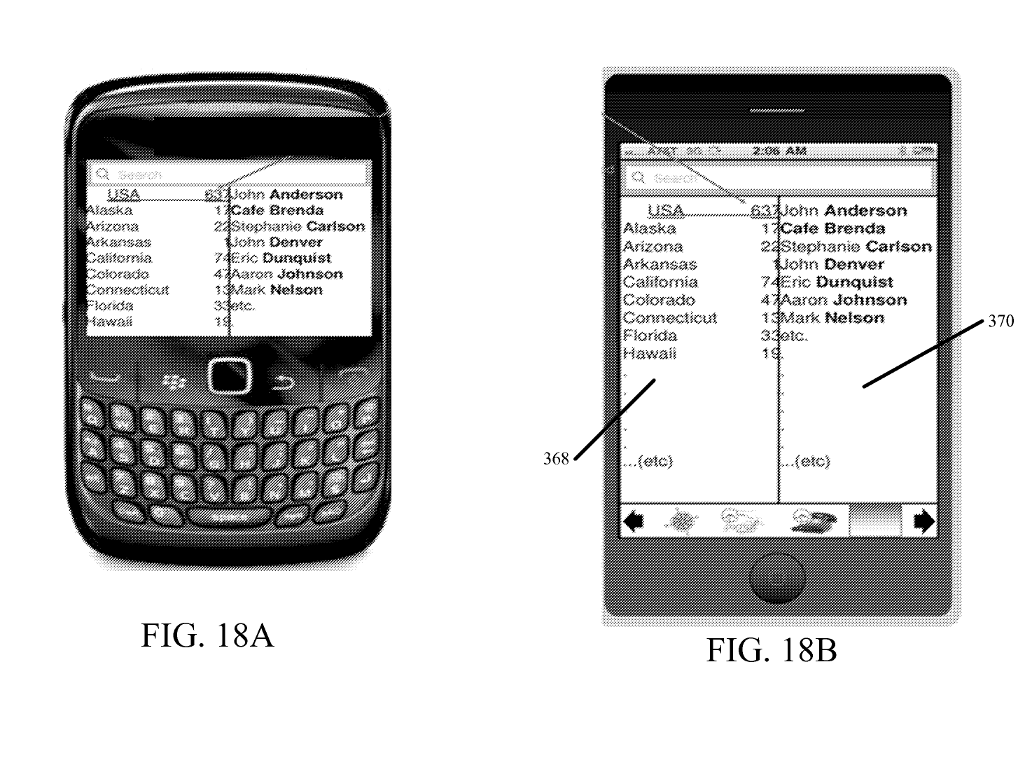

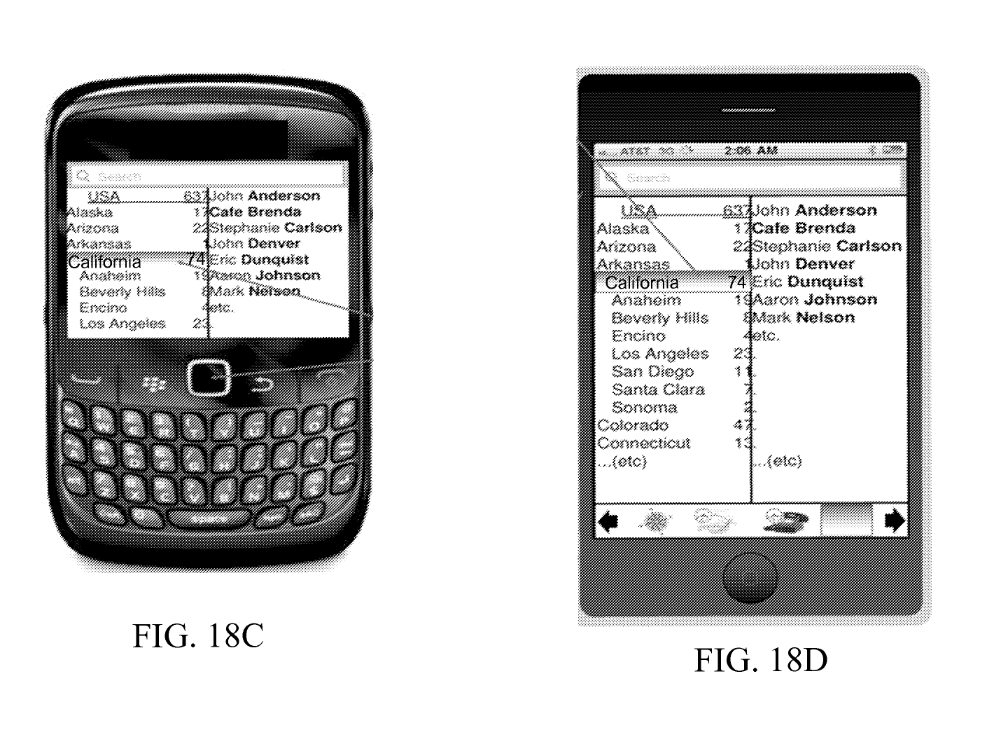

FIG. 17 is a flow diagram illustrating one embodiment of device 10 operating according to an atlas (or map search) function. FIGS. 18A-18D show illustrative user interfaces that can be generated by device 10 during the operation shown in FIG. 17.

Device 10 first receives a user input indicating that the user has selected the atlas function. This is indicated by block 341 in FIG. 17. Again, this can be done through a dropdown menu or in another suitable way. Then, device 10 operates in a similar fashion to the “Sort By Contact Date” function shown in FIGS. 13-14F. That is, when the atlas function is selected, device 10 generates an illustrative user interface display having two columns 368 and 370. Column 368 lists a geographic territory or location range having a certain granularity. In one embodiment, column 368 lists geographic territories as countries along with the number of contacts that have been entered in that country. Column 370 then lists, for a selected country, the contact information for the contact entries generated in a selected country in list 368. List 370 can list the contact information in alphabetical order, reverse alphabetical order, based on location, or otherwise. Listing the territories and contact entries at a first granularity (e.g., country) is indicated by block 343 in FIG. 17.

FIG. 17 also shows that, if the user selects one of the geographic areas in column 368, then device 10 displays the contacts made in that geographic area at a more fine granularity. This is indicated by blocks 345 and 347 in FIG. 17. For example, FIGS. 18A and 18B show that the user has selected the country USA. Thus, device 10 displays the contacts made in the USA by state. Only the states with positive data (e.g., the states where contacts have been made) are displayed so as not to overpopulate the user interface display unnecessarily. Column 368 shows that each states is displayed along with the number of contacts made in that state. Where the user highlights one of the states, then the contacts made in that state are displayed in column 370, in alphabetical order, or in any other order.

FIGS. 18C and 18D show that the user can manipulate device 10 so that it displays contacts, according to geographic area, in an even finer granularity. For instance, FIGS. 18C and 18D show that the user has selected the state “California”, which has 74 contacts. Device 10 then displays those contacts, according to geographic area of a more fine granularity, such as by city. FIGS. 18C and 18D show that the 74 contacts made in California are now broken out by the city where they were made. Column 370, then, displays the names of contacts made in a selected geographic region, such as a selected city, in alphabetical (or other) order.

It may happen that device 10 assigns locations to certain contact entries based on phone number. This can be done using a phone number-to-address index, for instance. However, the index may be incomplete, so device 10 may do its best to assign location information based only on area code. Under those circumstances, it may happen that, when a state is selected, there are contacts that are assigned to that state, because the state can be determined based on the area code where the contact was entered. However, the area code is not sufficient to assign a given contact entry to a specific city within a state. In that case, those contacts may show up at the top or bottom of the displayed list of cities, and they can be labeled accordingly. For instance, the cities may show up under a label “unsorted” or any other desired label.

A number of other features should also be noted. For instance, in one embodiment, device 10 has configuration settings that can be customized by a user, an administrator, or another person. By way of example, the particular screen generated when the contacts application is opened can be selected as a default screen. Thus, the user may want device 10 to open the contact application within a given function in the application, such as within the function that allows a new contact entry to be entered. Alternatively, the user may wish the contacts application to be opened by displaying a list of contacts in alphabetical order, or ordered based on geographic location (along with a map) as described above with respect to FIGS. 12A-12B.

Similarly, configurable items within each function can be set. For instance, under the mapping functions shown in FIG. 12A-12B, the zoom level of the map to be displayed, along with the size of the target, are illustratively settable by the user, as are various search criteria that can be used to generate the display. Additionally, of course, the date display format can illustratively be set by the user as well, so that it conforms to the conventions of the United States, of Europe, or of a different area, as desired.

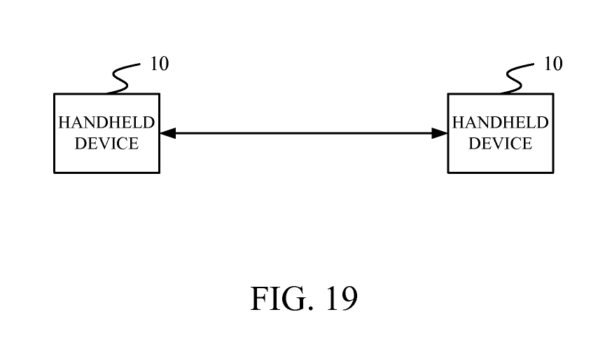

FIG. 19 shows one overall architecture in which device 10 can be used. FIG. 19 shows that a plurality of devices 10 can be coupled directly to one another, by a wired or wireless link. In that way, contact entries can be transferred back and forth among devices 10, they can be synchronized among devices 10, or devices 10 can communicate with one another, directly, for other purposes as well.

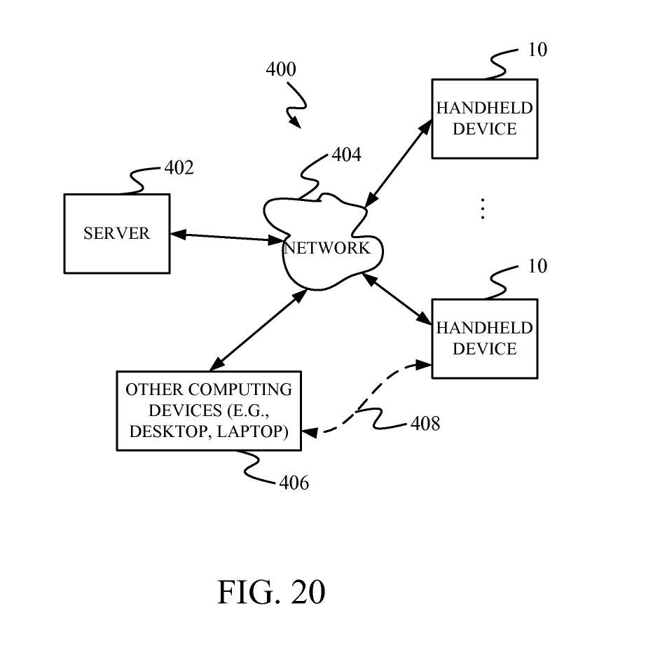

FIG. 20 shows another architecture 400 in which the present system can be used. Architecture 400 shows server 402 along with a set of handheld devices 10 connected to one another over network 404. Architecture 400 also shows an optional set of other computing devices (such as laptop computers, desktop computers, etc.) 406 which are connected to the other devices through network 404. In addition, architecture 400 shows that any given handheld device (or a set of handheld devices) 10 can be connected directly to another computing device such as a laptop or desktop computer 406 by a direct link 408. For instance, a user may have a cradle for receiving handheld device 10 and coupling it, through a wired connection, or through a wireless connection, to one of devices 406. This can be done for purpose of synchronizing the contacts in device 10 with those in device 406 (and vice versa). Of course, the direct connection 408 can be used for other purposes as well. For instance, application 43 can be hosted by a server and all of the functions described herein can be performed over network 404.

It will be noted that in some embodiments, the layout and user interface elements native to device 10 are used so there is continuity in user experience for the user. For example, the user interface layout and elements in the contact or phonebook application native to device 10 can be used. Of course, customized layout and user interface elements can be used as well, or instead of, those native to device 10.

Although the present invention has been described with reference to preferred embodiments, workers skilled in the art will recognize that changes may be made in form and detail without departing from the spirit and scope of the invention.

1. A computer-implemented method of creating a new contact entry record on a hand held computing device that includes a processor, the method comprising:
displaying, with the processor, a user interface on the hand held computing device having a user input element;
receiving user input to create a new contact entry record for a given person through the user input element, the user input including contact information for the new contact entry record that identifies the given person;
obtaining location information corresponding to the contact information that is indicative of a geographic location of the hand held computing device where the new contact entry record was created;
obtaining time information corresponding to the contact information that is indicative of a time when the new contact entry record was created;
storing, with the processor, the new contact entry record in a data store, the new contact entry record including the contact information, the associated location information and the associated time information;
receiving, at the processor, a user search input to search the data store for a desired contact entry record based on search criteria that includes at least one of input location information indicative of a location of the hand held computing device where the desired contact entry record was created and input time information indicative of a time when the desired contact entry record was created; and
displaying, on the hand held computing device, a list of contact entry records based on the search criteria.

2. The computer-implemented method of claim 1 wherein displaying a list of contact entry records comprises:
when the search criteria comprises input location information, identifying contact entry records in the data store based on a geographic distance between the location information associated with the contact entry records and the input location information.

3. The computer-implemented method of claim 1 wherein displaying a list of contact entry records comprises:
when the search criteria comprises input time information, identifying contact entry records in the data store based on a temporal distance between the time information associated with the contact entry records and the input time information.

4. (canceled)

5. The computer-implemented method of claim 1 wherein displaying a list of contact entries comprises:
automatically receiving a current location of the processor; and
displaying a map that includes the current location of the processor and contact points, located on the map, each contact point corresponding to a contact entry record and being located on the map at a location identified by associated location information in the content entry record.

6. The computer-implemented method of claim 5 wherein displaying a list of contact entries comprises:
displaying the contact entry points as icons that visually differ based on a context in which the associated contact entry was obtained.

7. A handheld computing device, comprising:
a data store that stores one or more computer readable contact entry records that each include contact information for a subject of the contact entry record along with additional information comprising at least one of:
a time stamp indicative of a time when the contact entry record was created, and
a location stamp indicative of a geographical location where the contact entry record was created;
a processor that receives a user search input and searches the data store to identify a desired contact entry record based on the user search input; and
a user interface display, the processor generating a display on the user interface display that shows the contact information and the additional information for the desired contact entry record.

8. The handheld computing device of claim 7 wherein the processor is configured to automatically store last contact information, associated with the identified contact entry, in the data store, the last contact information including a date that a user of the handheld computing device last contacted the subject of the identified contact entry.

9. The handheld computing device of claim 8 wherein the processor generates the display to show the last contact information.

10. The handheld computing device of claim 9 wherein the last contact information displayed includes a mode portion indicative of a mode of communication used to make the last contact.

11. The handheld computing device of claim 10 wherein the last contact information displayed includes a content portion that shows a substantive content of the last contact.

12. The handheld computing device of claim 7 wherein the user search input comprises a request to display contacts and wherein the processor generates the display by displaying a list of the contact entries grouped according to a date range having a first granularity.

13. The handheld computing device of claim 12 wherein the processor receives a second user input to increase granularity and wherein the processor generates the display by displaying a list of the contact entries grouped according to a date range having a second granularity, that is increased relative to the first granularity.

14. The handheld computing device of claim 7 wherein the user search input comprises a request to display contacts and wherein the processor generates the display by displaying a list of the contact entries grouped according to a geographic area having a first granularity.

15. The handheld computing device of claim 14 wherein the processor receives a second user input to increase granularity and wherein the processor generates the display by displaying a list of the contact entries grouped according to a geographic area having a second granularity, that is increased relative to the first granularity.

16. The handheld computing device of claim 7, wherein the user search input comprises at least one of:
input location information indicative of a time when the desired contact entry record was created; and
input time information indicative of a location of the hand held computing device where the desired contact entry record was created.

17. The handheld computing device of claim 16, wherein the user search input comprises input location information and the processor searches the data store to identify contact entries based on a geographic distance between the location stamp associated with the identified contact entry and the input location information, and wherein the processor generates the display by displaying contact entries in order based on the geographic distance.

18. The handheld computing device of claim 17 and further comprising:
a location system that provides an output indicative of a current geographic location of the handheld computing and wherein the processor receives the input location information by automatically receiving the current geographic location from the location system.

19. The handheld computing device of claim 18 wherein the processor displays the contact entries by displaying a map that includes the current geographic location and contact points, located on the map, each contact point corresponding to a contact entry and being located on the map at a location identified by the associated location stamp.

20. A hardware computer readable medium storing computer executable instructions which, when executed by a computer, cause the computer to perform a method, comprising:
generating a user interface display on the computer that receives contact information from a user, the contact information corresponding to a given person, other than the user, that is a subject of the contact information;
automatically generating a time stamp that identifies a time that the contact information is received from the user through the user interface display on the computer;
automatically generating a location stamp that identifies a geographical location of the computer where the contact information is received from the user through the user interface display on the computer;
storing the contact information, the time stamp and the location stamp as a contact entry in a data store;
receiving a user input requesting display of the contact entry; and
generating a user interface display for the identified contact entry, including a display of the contact information for the identified contact entry, the time stamp for the identified contact entry and the location stamp for the identified contact entry.

21. The hardware computer readable medium of claim 20, wherein the computer comprises a handheld mobile device.
